(19) United States
(12) Patent Application Publication
(10) Pub. No.: US 2025/0050210 A1
(43) Pub. Date: Feb. 13, 2025

(54) VIDEO PROCESSING APPARATUS, VIDEO PROCESSING METHOD, AND PROGRAM

(71) Applicant: Sony Group Corporation, Tokyo (JP)

(72) Inventor: Katsumi NAGAI, Kanagawa (JP)

(73) Assignee: Sony Group Corporation, Tokyo (JP)

(21) Appl. No.: 18/684,191

(22) PCT Filed: Mar. 17, 2022
(86) PCT No.: PCT/JP2022/012162

§ 371 Date: Feb. 16, 2024

(30) Foreign Application Priority Data
Sep. 3, 2021 (JP) 2021-143777

(51) Int. Cl. A63F 13/52; G06V 10/88; G06V 20/40

(52) U.S. Cl. CPC A63F 13/52; G06V 10/88; G06V 20/44

(57) ABSTRACT

Provided are a video processing apparatus, a video processing method, and a program capable of specifying an instance corresponding to a certain instance in a plurality of input videos and creating an output video including the instances. The video processing apparatus 100 includes: an information creation unit configured to create video creation information on the basis of a plurality of triggers detected from a plurality of input videos; and a video processing unit 106 configured to determine a material video to be associated with creation of an output video from the plurality of input videos, on the basis of the video creation information.

### TECHNICAL FIELD

The present technology relates to a video processing apparatus, a video processing method, and a program.

### BACKGROUND ART

In various competitive video games and competitions called electronic sports (e-sports), videos are used to provide a viewer with a game situation. For example, in a case where there is a venue where viewers can enter, a video is displayed on a screen installed in the venue, or a video is provided through a video distribution site or the like. The provided video is, for example, a gameplay video of a player in a game currently being played or a processed video thereof, or a highlight scene obtained by cutting out a highlight part of a match. There is Patent Document 1 as a technique for extracting a highlight scene from a video that can be used for such an application.

### CITATION LIST

### Patent Document

Patent Document 1: Japanese Patent Application Laid-Open No. 2020-179045

### SUMMARY OF THE INVENTION

### Problems to be Solved by the Invention

However, the technique described in Patent Document 1 has a problem that videos of other players related to highlight in a video of a specific player cannot be simultaneously specified.

For example, when a video of an instance in which a player wins against another player in a certain game is extracted, a gameplay video of the losing player is not simultaneously specified. In this case, it is not possible to represent how the winning player looks from the viewpoint of the losing player. Furthermore, there is a problem that it is not possible to represent a tense situation itself where which side will win is unknown, to the viewer in real time.

The present technology has been made in view of such a point, and an object of the present technology is to provide a video processing apparatus, a video processing method, and a program capable of specifying an instance corresponding to a certain instance in a plurality of input videos and creating an output video including the instances.

### Solutions to Problems

In order to solve the above-described problem, a first technology is a video processing apparatus including: an information creation unit configured to create video creation information on the basis of a plurality of triggers detected from a plurality of input videos; and a video processing unit 106 configured to determine a material video to be associated with creation of an output video from the plurality of input videos, on the basis of the video creation information.

Furthermore, a second technique is a video processing method including: creating video creation information on the basis of a plurality of triggers detected from a plurality of input videos; and determining a material video to be associated with creation of an output video from the plurality of input videos, on the basis of the video creation information.

Furthermore, a third technique is a program for causing a computer to execute a video processing method including: creating video creation information on the basis of a plurality of triggers detected from a plurality of input videos; and determining a material video to be associated with creation of an output video from the plurality of input videos, on the basis of the video creation information.

### BRIEF DESCRIPTION OF DRAWINGS

FIG. 1A is a view illustrating an example of a gameplay video, and FIG. 1B is a view illustrating an example of a player video.

FIG. 2A is a view illustrating an example of a map video, and FIG. 2B is a view illustrating an example of a free viewpoint video.

FIG. 3 is a block diagram illustrating a configuration of a video processing apparatus 100.

FIG. 4 is a flowchart illustrating overall processing of the video processing apparatus 100.

FIG. 5 is a flowchart illustrating processing of a pre-processing unit 101.

FIG. 6 is an explanatory view of video information.

FIG. 7 is a flowchart illustrating processing of a first information creation unit 103.

FIG. 8 is a flowchart illustrating trigger detection processing.

FIG. 9 is a table illustrating variations of a trigger detection method.

FIG. 10 is an explanatory view of a trigger detection method.

FIG. 11 is an explanatory view of a trigger detection method.

FIG. 12 is an explanatory view of a trigger detection method.

FIG. 13 is an explanatory view of a trigger detection method.

FIG. 14 is an explanatory view of trigger information.

FIG. 15 is a flowchart illustrating event specifying processing.

FIG. 16 is an explanatory view of a method of evaluating a corresponding trigger.

FIG. 17 is an explanatory view of a method of evaluating a corresponding trigger.

FIG. 18 is an explanatory view of a method of evaluating a corresponding trigger.

FIG. 19 is an explanatory view of event information.

FIG. 20 is a flowchart illustrating processing of a second information creation unit 105.

FIG. 21 is a flowchart illustrating event scene information creation processing.

FIG. 22 is an explanatory view of event scene information.

FIG. 23 is an explanatory view of event scene information creation.

FIG. 24 is a view illustrating a first example of an output video.

FIG. 25 is a view illustrating a second example of an output video.

FIG. 26 is a view illustrating a third example of an output video.

FIG. 27 is a flowchart illustrating processing of a video processing unit 106.

FIG. 28 is an explanatory view of a premise of a second embodiment.

FIG. 29 is a view illustrating an example of a gameplay video in the second embodiment.

FIG. 30 is a view illustrating information to be associated with a video ID.

FIG. 31 is a flowchart illustrating processing of a first information creation unit 103 in the second embodiment. 30

FIG. 32 is a view illustrating estimated position information to be associated with a video ID.

FIG. 33 is a flowchart illustrating event specifying processing in the second embodiment.

FIG. 34 is an explanatory view of a method of calculating an evaluation value.

FIG. 35 is an explanatory view of event information.

FIG. 36 is an explanatory view of posture estimation of a player.

### MODE FOR CARRYING OUT THE INVENTION

Hereinafter, embodiments of the present technology will be described with reference to the drawings. Note that the description will be made in the following order.
<1. First Embodiment>
[1-1. Premises]
[1-2. Configuration of video processing apparatus 100]
[1-3. Processing by video processing apparatus 100]
[1-3-1. Overall processing]
[1-3-2. Processing in pre-processing unit 101]
[1-3-3. Processing in first information creation unit 103]
[1-3-4. Processing in second information creation unit 105]
[1-3-5. Processing in video processing unit 106]
<2. Second Embodiment>
[2-1. Premises]
[2-2. Processing in video processing apparatus 100]
[2-3. Another example of trigger detection processing]
[2-3-1. First example]
[2-3-2. Second Example]
<3. Modifications>

### 1. First Embodiment

### [1-1. Premises]

The present technology will be described with an example of providing a viewer with a video of a competitive game in which a large number of players descend on a vast field and aim to win and survive at the field by the players battling each other such as shooting or fighting, in a video game or a personal computer (PC) game. Hereinafter, a game that the player is playing may be expressed as a match, and a state where the player is playing the game may be expressed as a state where the match is in progress.

The player is a person who plays a game. The viewer is a person other than the player, such as an audience who views a game video displayed on a screen, a monitor, or the like installed in a venue, or a game video distributed by a video distribution service on the Internet or the like. Furthermore, a side providing the video is referred to as an organizer.

A video processing apparatus 100 creates a video (hereinafter, referred to as an output video) to be provided for viewing by the viewer, by using, as a processing target video (hereinafter, referred to as an input video), a video obtained by image capture of a gameplay video, a gameplay video output from a game machine or the like, a video obtained by image capture of a player with a camera, or the like, which are input via a network.

Examples of a video source that supplies the input video to the video processing apparatus 100 include: a game machine (including a home game machine, a portable game machine, a personal computer, and the like) used by each player; a gameplay-video capturing device such as a capture board that captures an image of a video output from the game machine and displayed; a player image capture camera such as a web camera that captures an image of each player; and a game server that manages game execution and outputs information and a video for game watching.

Examples of the input video include: a video output from a game machine used by each player; a gameplay video obtained by image capture by the gameplay-video capturing device; a video of a player obtained by image capture by the player capturing camera; and a video output from a game server or the like that manages game execution and outputs information and a video for game watching. These input videos are input from the video source to the video processing apparatus 100 via a network. The network may be a wired network or a wireless network, and may be any network as long as the input video can be transmitted. The network may be a dedicated line or the Internet regardless of wired or wireless.

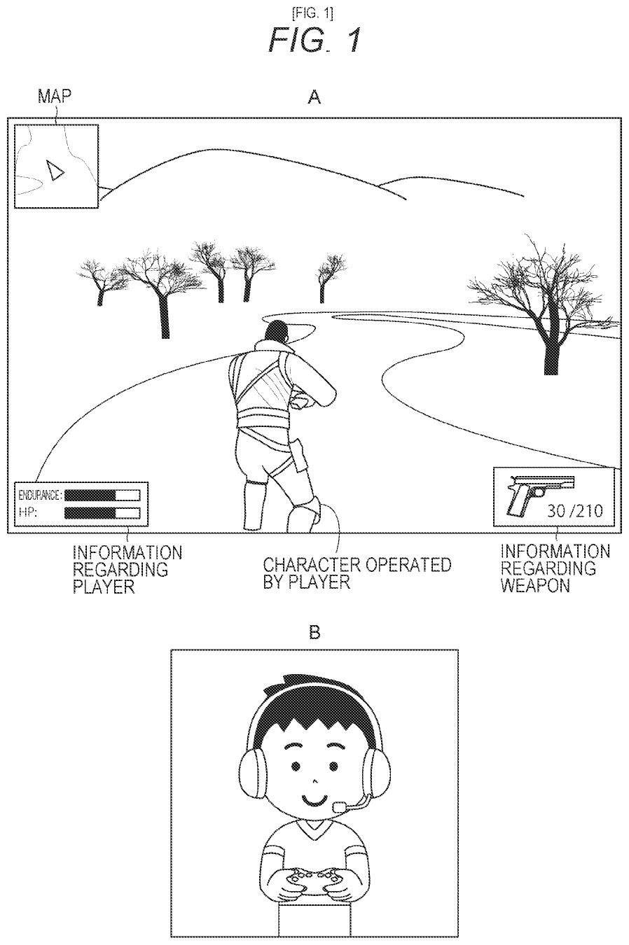

FIG. 1A is an example of a gameplay video of a player's viewpoint obtained by image capture by the gameplay-video capturing device such as a capture board that captures a video input from a game machine or a video output from the game machine and displayed. Hereinafter, the game video from the player's viewpoint is referred to as a gameplay video.

The gameplay video may be a so-called first person shooter (FPS) that displays a space in the game from the viewpoint of a person himself/herself as a character operated by the player. Alternatively, the gameplay video may be a so-called third person shooter (TPS) in which a player character to be operated is displayed on a screen, and a space in the game is displayed in overhead view or from a viewpoint over a shoulder of a character different from the character to be operated by the player, or other display formats may be used.

The gameplay video includes, for example, a state on the game field, a character operated by the player, an enemy character operated by another player, information indicating a situation of the character or the game, and the like.

For example, as illustrated in FIG. 1A, a map indicating a position of the player on the game field is displayed on the upper left of the gameplay video. Furthermore, a gauge indicating player's vitality (may be referred to as armor or the like in some games), HP (may also be referred to as physical strength, life, or the like in some games), ability, and the like is displayed as information regarding the player on the lower left. Hereinafter, numerical values and gauges directly related to survival of a character including vitality, HP, and the like are referred to as vitality. There may be only one type of vitality or a plurality of types of vitality depending on the game, and FIG. 1A illustrates a situation where there are two of vitality and HP. The vitality is decreased when being attacked by another player or due to a trap on the game field, and the like. It can be determined that the player has been destroyed in case where all the gauges are lost or a gauge having a high priority set for each game is first lost.

Furthermore, information regarding a weapon used by the player is displayed at the lower right of the gameplay video. Examples of the information regarding the weapon include an icon indicating a type of the weapon and numerical information such as the number of bullets of the weapon and the number of use limits. In addition to the weapon, information regarding a tool (item) used by the player may also be displayed.

Note that the contents and the display position of the information regarding the player and the information regarding the weapon are merely examples. For example, the gauge indicating the vitality may be a specific numerical value or the like, the representation position of the map may be another place such as the lower right, or other information may be displayed in the gameplay video.

FIG. 1B is an example of a video of a player obtained by image capture by an imaging device such as a web camera. With this video, the viewer can see expression and behavior of the player participating in the game. Hereinafter, this video is referred to as a player video.

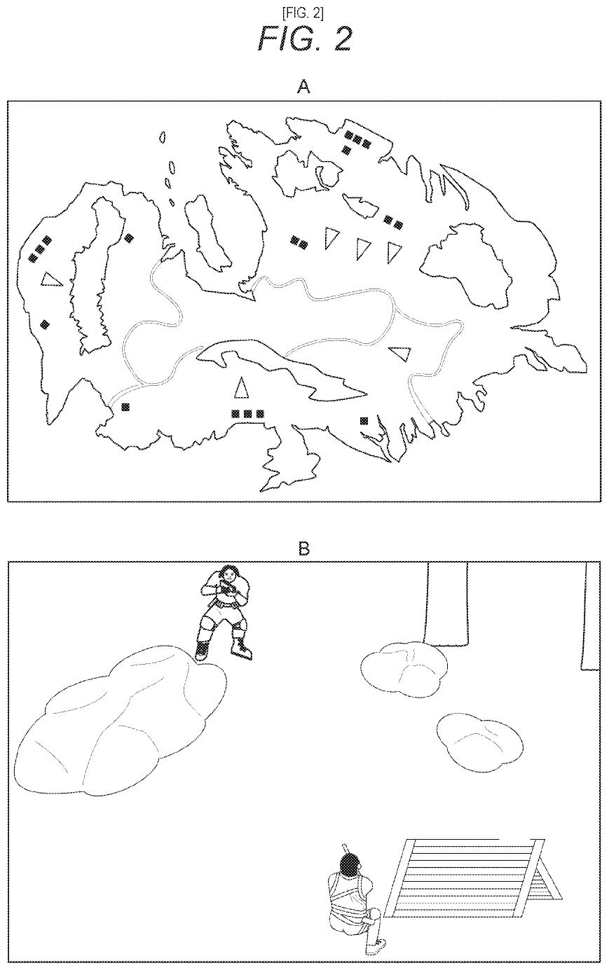

FIG. 2A is an example of a map video showing the entire game field. A plurality of triangles illustrated in FIG. 2A indicates individual players, and positions and orientations of the players are visually indicated on the map by the triangles. However, the map video may be a video in which information regarding the positions and orientations of the players is not expressed by text or figures. Furthermore, the map video may be replaced with a map image showing the entire game field and prepared in advance without being received from the video source.

FIG. 2B is an example of a free viewpoint video in which a viewpoint position can be freely moved on the game field. This free viewpoint video is a video from a viewpoint different from the viewpoint of the player, and the viewpoint position can be moved by the organizer or the like at any time during continuation of the game play.

The video processing apparatus 100 creates an output video that attracts a viewer's interest and an output video that the viewer can enjoy more, by estimating and specifying a video relating to a player involved when a battle or an attack occurs, for example, a player who has attacked and a player who has been attacked, in the competitive game described above.

Note that, in the first embodiment, it is assumed that various video sources continuously supply input videos to the video processing apparatus 100 when the match is in progress, and the video processing apparatus 100 can obtain gameplay videos of all players participating in the match.

### [1-2. Configuration of Video Processing Apparatus 100]

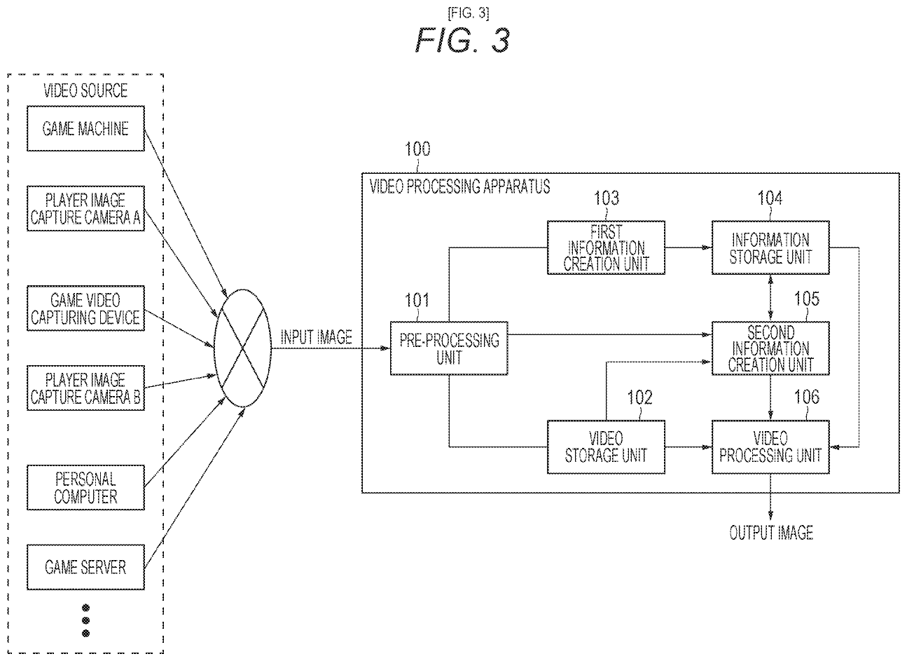

Next, with reference to FIG. 3, a configuration of the video processing apparatus 100 will be described. The video processing apparatus 100 includes a pre-processing unit 101, a video storage unit 102, a first information creation unit 103, an information storage unit 104, a second information creation unit 105, and a video processing unit 106. Note that an arrow connecting individual units indicates a main flow of a video and information, and a video, information, and the like can be exchanged by physical or wireless connection.

The pre-processing unit 101 adds video information to an input video input from a video source, and outputs a set of the input video and the video information to the video storage unit 102, the first information creation unit 103, and the second information creation unit 105. Furthermore, when a match ends, match end information is output to the video storage unit 102 and the second information creation unit 105.

The video storage unit 102 stores the input video and the video information acquired from the pre-processing unit 101 in a format that can be referred to by each processing unit. The video storage unit 102 is in a standby state until acquiring the input video and the video information from the pre-processing unit 101. Upon receiving the input video and the video information from the pre-processing unit 101, the video storage unit 102 stores a match ID unique to each match and a current time as match start time, and then transitions to a video storage state. When the match end information is received from the pre-processing unit 101 in the video storage state, the current time is stored as match end time for the current match ID, and then a transition is made to the standby state again.

The first information creation unit 103 detects a plurality of triggers from the input video on the basis of the input video and the video information acquired from the pre-processing unit 101, and creates trigger information and event information which are video creation information. The first information creation unit 103 outputs the created trigger information and event information to the information storage unit 104.

The trigger is a characteristic instance in the game, for example, a change on a video. Specifically, for example, the trigger is an instance in which a player attacks another player or an enemy, a player is attacked by another player or an enemy, a player destroys another player or an enemy, a player is destroyed by another player or an enemy, or the like.

The trigger includes a target trigger and a corresponding trigger. In a case where a trigger of “having attacked another player” detected in a gameplay video of a certain player is set as a target trigger, a trigger of “being attacked by another player” should be detected in a gameplay video of another player as a corresponding instance. Such a trigger having a relationship corresponding to the target trigger is defined as a corresponding trigger.

An event means an instance that includes the target trigger and the corresponding trigger and in which a relationship between players that has changed a situation of the game can be specified and estimated.

The information storage unit 104 receives the trigger information and the event information created by the first information creation unit 103, and stores the trigger information and the event information in a format that can be referred to by each processing unit. Furthermore, also when the statistical information, the event scene information, and the like created by the second information creation unit 105 are received, the statistical information, the event scene information, and the like are stored in a format that can be referred to by each processing unit.

The second information creation unit 105 reads the trigger information and the event information stored in the information storage unit 104, and creates statistical information and event scene information which are video creation information. The second information creation unit 105 can output some or all of the created statistical information and event scene information to the information storage unit 104.

The event scene is a temporal interval including a plurality of events, that is, a temporal interval in which a situation of the game has changed. Specifically, for example, there are a scene in which a certain player destroys another player, and a skirmish scene in which attacking and being attacked frequently occur between a plurality of players.

Furthermore, when the second information creation unit 105 receives the match end information from the pre-processing unit 101, the second information creation unit 105 performs match end processing.

The video processing unit 106 acquires the trigger information, the event information, the event scene information, and the statistical information as necessary input videos and video creation information from the video storage unit 102, the information storage unit 104, and the second information creation unit 105, and uses these pieces of information to determine a video (hereinafter, referred to as a material video) to be associated with creation of an output video from a plurality of input videos. Then, the video processing unit 106 creates an output video by using the material video. The created output video is output to an outside via a network or the like, and provided to the viewer. The output video is provided to the viewer by being displayed on a screen or a monitor installed in a venue or the like, or by being made available in a video distribution service on the Internet.

The video processing apparatus 100 is configured as described above. Each unit constituting the video processing apparatus 100 includes an arithmetic processing device such as a central processing unit (CPU) or a graphics processing unit (GPU), a primary storage device such as a dynamic random access memory (DRAM), and a secondary storage device such as a hard disc drive (HDD) or a solid state drive (SSD). It is assumed that the first information creation unit 103, the second information creation unit 105, and the video processing unit 106 constituting the video processing apparatus 100 can hold data and information necessary for processing by themselves by using the primary storage device, the secondary storage device, or the like.

Note that a connection corresponding to an arrow (not illustrated) may be additionally implemented as necessary to exchange videos and information. For example, by adding a connection such that the input video which is the output of the pre-processing unit 101 and the information regarding the input video can be supplied to the video processing unit 106, the time through the video storage unit 102 may be reduced.

An electronic device such as a personal computer, a tablet terminal, or a smartphone, or a server device may have a function as the video processing apparatus 100. Furthermore, the video processing apparatus 100 may be configured as a device that operates in the electronic device or the server device. Furthermore, a plurality of processing units may be integrated into one electronic device, server device, or the like, or one processing unit may be configured to be distributed among a plurality of electronic devices, server devices, or the like. Furthermore, it is assumed that all the electronic devices, server devices, and the like used here are adjusted to indicate the same current time.

Furthermore, the video processing apparatus 100 may be realized by executing a program. In a case where the video processing apparatus 100 is realized by executing a program, the program may be installed in the electronic device or the server device described above in advance, or may be distributed by download, a storage medium, or the like and installed by a user himself/herself.

### [1-3. Processing by Video Processing Apparatus 100]

### [1-3-1. Overall Processing]

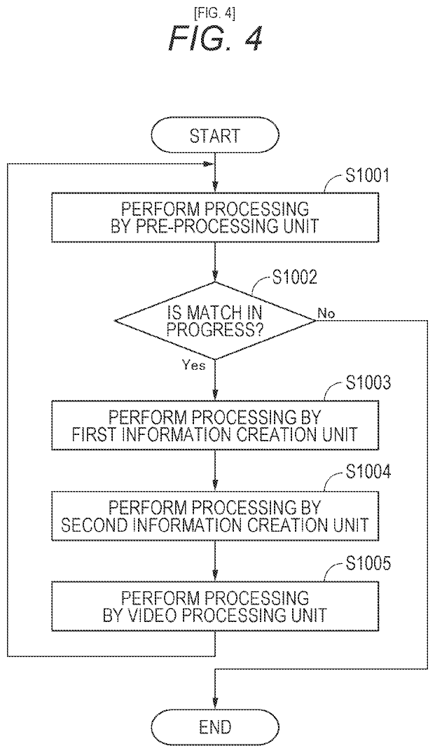

Next, processing by the video processing apparatus 100 will be described. First, overall processing will be described with reference to FIG. 4. Note that, in all the flowcharts including FIG. 4, arrows merely indicate only an order of processing, and information transfer is not limited thereto. Furthermore, processing of the video storage unit 102 and the information storage unit 104 is not described because the processing is performed across a plurality of units as needed.

First, in step S1001, processing is performed by the pre-processing unit 101 that has acquired an input video from a video source. Next, in step S1002, the pre-processing unit 101 determines whether or not a match is in progress.

Whether or not a match is in progress can be determined, for example, by an administrator of a game competition or the like directly inputting information indicating that the match has started, to the video processing apparatus 100. Furthermore, the determination can also be made on the basis of a specific video in a game, for example, whether or not text such as “match start” displayed at a predetermined position of a video has been recognized by pattern recognition processing or text recognition processing. Furthermore, the determination may be made on the basis of an operation status of the game device.

When the match ends, the processing ends (No in step S1002).

In a case where the match is continuing, the processing proceeds to step S1003 (Yes in step S1002), and the first information creation unit 103 performs processing.

Next, in step S1004, the second information creation unit 105 performs processing. Then, in step S1005, the video processing unit 106 performs processing to create an output video. Thereafter, the processing returns to step S1001, and the video processing apparatus 100 repeats the processing of steps S1001 to S1005 as long as the match continues.

### [1-3-2. Processing in Pre-Processing Unit 101]

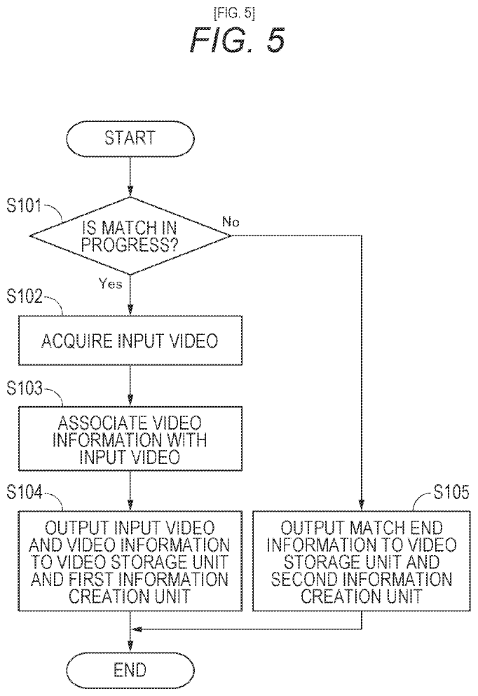

Next, processing by the pre-processing unit 101 will be described with reference to FIG. 5.

First, in step S101, it is determined whether or not a match is in progress. In a case where the match is in progress, processing proceeds to step S102 (Yes in step S101), and the pre-processing unit 101 acquires a plurality of input videos from a video source.

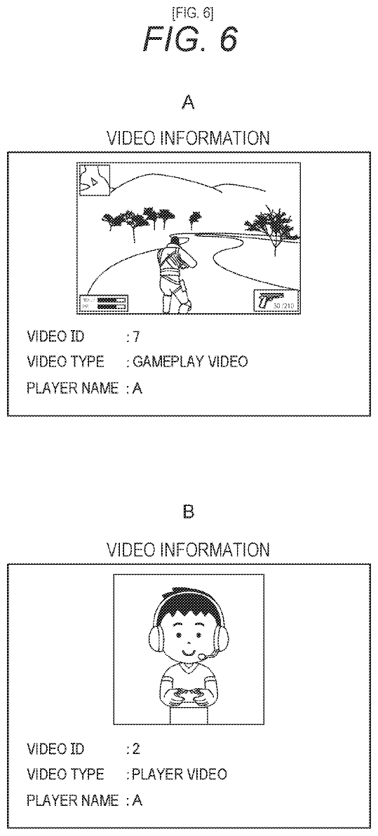

Next, in step S103, video information is associated with each of the input videos. The pre-processing unit 101 associates one piece of video information with one piece of input video data. As illustrated in FIG. 6, the video information includes at least a video ID for enabling identification of an input video in the video storage unit 102 and a video type indicating what the input video shows. Examples of the video type include the gameplay video, the player video, the map video, the free viewpoint video, and the like described with reference to FIGS. 1 and 2. FIG. 6A is an example of video information to be associated with an input video whose video type is the gameplay video. FIG. 6B is an example of video information to be associated with an input video whose video type is the player video.

For the video type, the organizer or the like may input information indicating the video type to the video processing apparatus 100 in advance, on the basis of a video source or a communication path. For example, an input video from Play Station 5 (registered trademark of Sony Corporation) which is a game machine is the gameplay video, an input video from a web camera is a player video of Player A, and the like. The pre-processing unit 101 receives device identification information together with the input video from a device that is the video source, and specifies which device has output the input video, so that a video type input by a person in advance can be associated with the input video.

Furthermore, the pre-processing unit 101 may automatically determine the video type on the basis of a communication path or the like. Moreover, the video type may be determined by recognizing a scene or an object in the input video by scene recognition processing, object recognition processing, or the like.

Furthermore, the video information includes a player name for identification of a player. In a case where the player name is included in the video information, the player name set in advance is associated with a video whose video type is “player video” or “gameplay video”. Note that the player name is not essential, and may also be included in the video information as necessary.

Next, in step S104, the pre-processing unit 101 outputs a set of the input video and the video information to the video storage unit 102 and the first information creation unit 103. Then, the processing ends.

The description returns to step S101. In a case where a match is not in progress in step S101, the processing proceeds to step S105 (No in step S101), it is regarded that the match is ended, and the pre-processing unit 101 outputs the match end information to the video storage unit 102 and the second information creation unit 105. The match end information includes at least information that can be recognized as the match end information by the video storage unit 102 and the second information creation unit 105.

### [1-3-3. Processing in First Information Creation Unit 103]

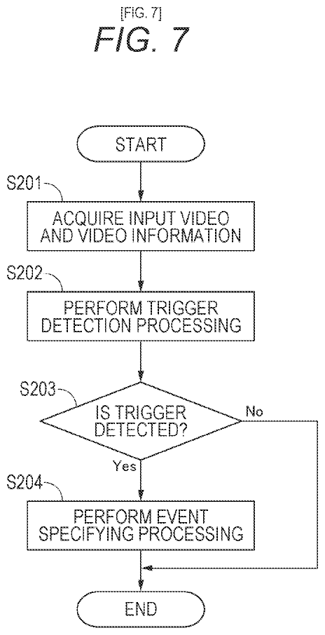

Next, processing in the first information creation unit 103 will be described with reference to FIG. 7. First, in step S201, the first information creation unit 103 acquires a set of an input video and video information output from the pre-processing unit 101. Note that the first information creation unit 103 executes the processing of FIG. 7 for every set of the input video and the video information, and performs synchronization at each stage of FIG. 7. Note that, it is assumed that the acquired input video is held by the first information creation unit 103, and can be freely referred to until the processing of FIG. 7 is completed.

Next, in step S202, the first information creation unit 103 performs trigger detection processing. In a case where a trigger is detected, the processing proceeds from step S203 to step S204, and the first information creation unit 103 performs event specifying processing.

Whereas, in a case where a trigger is not detected, the event specifying processing is not performed, and the processing ends (No in step S203). The processing in the first information creation unit 103 is performed as described above.

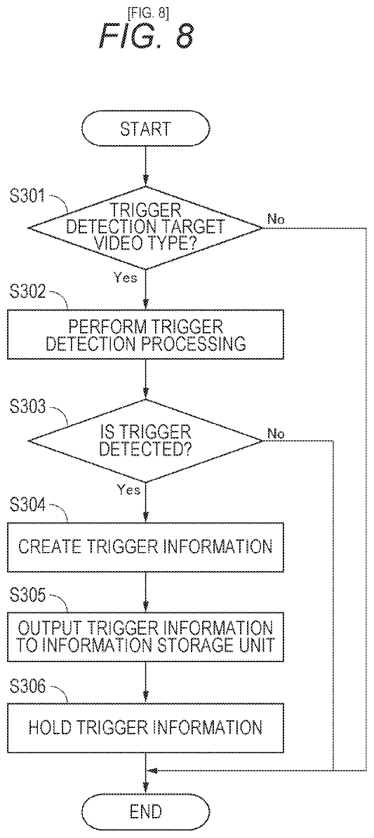

Next, the trigger detection processing of step S202 will be described with reference to FIG. 8.

First, in step S301, the first information creation unit 103 refers to a video type included in video information associated with the input video, and determines whether or not the input video is of a video type that is a target of the trigger detection processing set in advance.

For this purpose, it is necessary to set in advance a video type of an input video to be subjected to the trigger detection processing. For example, in a case of performing the trigger detection processing on the gameplay video and the player video, the video types of the gameplay video and the player video are set as the trigger detection target video type. Note that any input video can be set as the trigger detection target video type.

In a case where the input video is not of the video type of the trigger detection target, the processing ends without performing the trigger detection processing (No in step S301).

Whereas, in a case where the input video is of the trigger detection target video type, the processing proceeds to step S302 (Yes in step S301). In a case where there is a plurality of input videos as the trigger detection target type, the processing in and after step S302 is performed on each of the plurality of input videos.

Next, in step S302, the first information creation unit 103 performs the trigger detection processing on the input video that is the trigger detection target video type. In the trigger detection processing, a plurality of detection methods set in advance are executed, and a trigger corresponding to each detection method is regarded to be detected when the trigger is detected. Note that, in the trigger detection processing, it is assumed that trigger detailed information corresponding to each trigger detection method can be acquired.

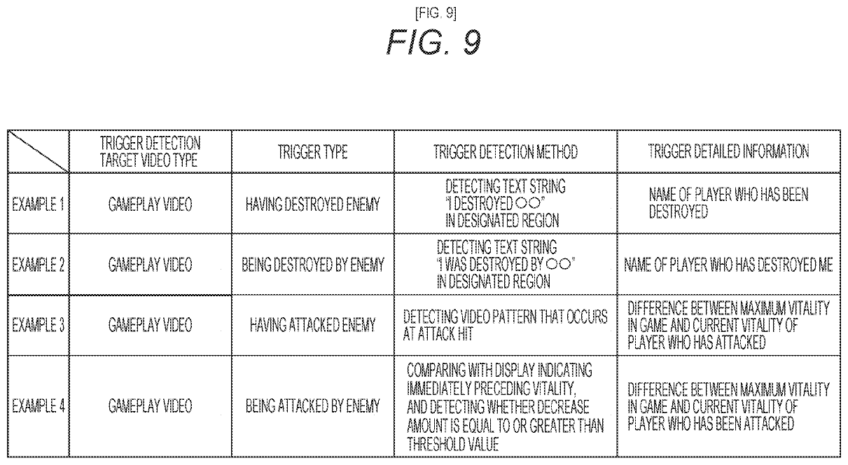

In order to perform the trigger detection processing, as illustrated in FIG. 9, a plurality of combinations of the trigger detection target video type, the trigger type, the trigger detection method, and the trigger detailed information is set in advance.

In Example 1 of FIG. 9, the trigger detection processing is performed on the gameplay video, in which the type of the trigger to be detected is an in-game instance of “having destroyed an enemy”, and the trigger detection method is to detect text “I destroyed ∘∘” designated in advance in a predetermined region in the gameplay video. Moreover, the name of a player who has destroyed is acquired as the trigger detailed information.

Note that details of FIG. 9 are merely an example, and it is possible to add and delete combinations or change each item of the trigger type, the trigger detection method, and the like in accordance with a game, a play mode thereof, or the like.

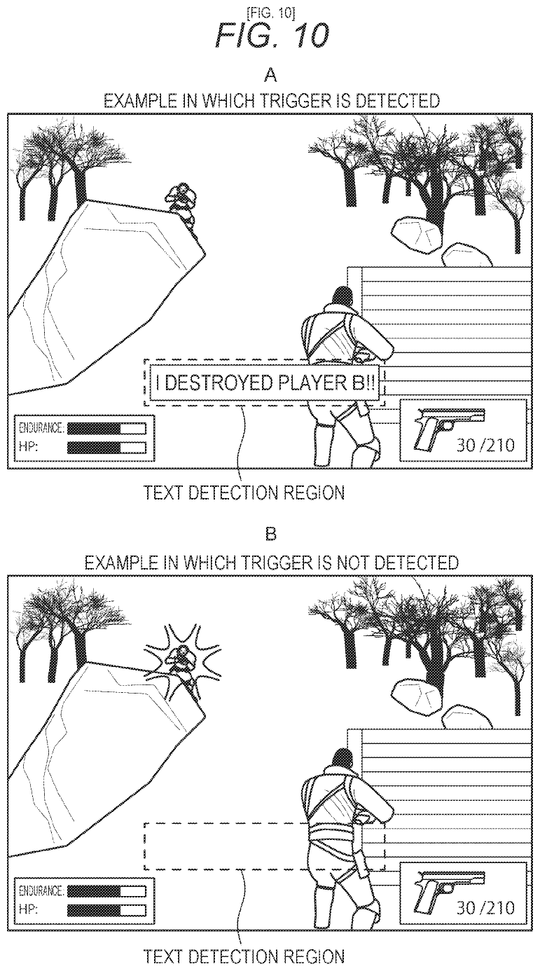

Here, trigger detection methods will be described with reference to FIGS. 10 to 13. FIG. 10 illustrates a trigger detection method by detecting text designated in advance in the gameplay video. The text is, for example, “I destroyed!!”. In this method, it is necessary to designate a text detection region in the gameplay video in advance. Then, in a case where the designated text is detected in the text detection region as illustrated in FIG. 10A by using a known text recognition technique, it means that the trigger is detected. Whereas, as illustrated in FIG. 10B, in a case where the designated text is not detected in the text detection region, it means that the trigger is not detected.

At that time, a player name detected in the text detection region can be stored as the trigger detailed information. Note that, in a case where text such as “I was destroyed by (enemy player name)!!” is displayed in a gameplay video of a player on the destroyed side, the trigger can be detected by detecting text “I was destroyed!!” in the text detection region by using a similar method. Note that the text may be detected from the entire gameplay video without designating the text detection region.

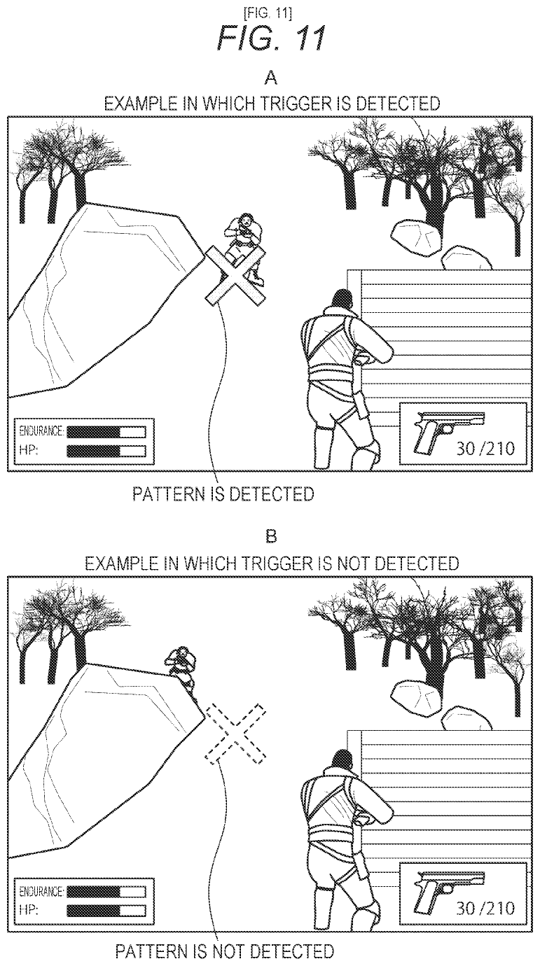

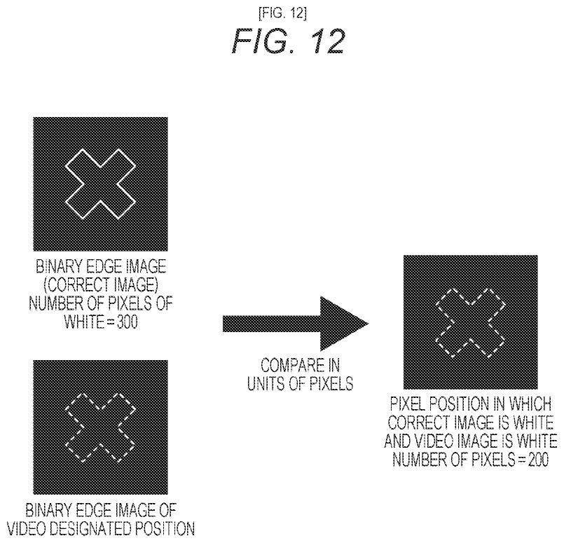

FIGS. 11 and 12 are examples of a trigger detection method by detecting a video pattern when a predetermined in-game instance occurs and calculating pattern detailed information. Here, an example in which the predetermined instance is an instance “attack has hit” will be described.

In this method, it is assumed that information such as a position, a shape, and color of a pattern of a video displayed at the time of an attack hit is grasped in advance, and a trigger is detected when the same pattern is detected from the gameplay video. In FIG. 11, it is assumed that an X shape indicated by a dotted line is a pattern displayed in the video at the time of an attack hit.

In the determination as to whether or not the pattern has been detected, first, a binary edge image (correct image) of the pattern prepared in advance as illustrated in FIG. 12 and an edge image binarized with a threshold value th1 at a designated position of the gameplay video are acquired, and the binary edge image and the edge image are compared pixel by pixel. Then, a number of pixels with edges in both the correct image and the edge image acquired from a designated position of the video is calculated, and determination is made on the basis of whether a matching degree calculated by the following Formula (1) is equal to or greater than a threshold value th2.

Matching degree=(number of pixels of white after comparison)/(number of pixels of white of correct image) [Formula 1]

As a result, in a case where the pattern is detected from the input video as illustrated in FIG. 11A, it means that the trigger is detected. Whereas, in a case where the pattern is not detected from the input video as illustrated in FIG. 11B, it means that the trigger is not detected.

In addition, there is also a method of calculating an index such as a luminance average or an RGB color average at a pre-designated position of a pattern in advance, and determining that a trigger is detected when a difference from a similar index at the designated position of the video is equal to or less than a threshold value th3. Moreover, there is also a method of preparing a correct pattern image or a correct pattern luminance image at a designated position, and determining that a trigger is detected when a difference between the pattern image and a video at the pre-designated position is equal to or less than a threshold value th4. As the trigger detection method, any of the methods described above may be used, or a combination thereof may be used.

Furthermore, a case where the position, the color, or the like of the pattern displayed at the time of an attack hit is not constant can also be handled, by designating these ranges to be wide, calculating the matching degree, the index, and the like for a plurality of times while displacing the correct image with respect to an inside of the range, and determining whether or not the pattern is detected by the method described above. Furthermore, patterns can be learned using a technique such as deep learning and used for trigger detection. Moreover, even in a case where the pattern is text or a numerical value, it is possible to perform trigger detection on the basis of whether the text or the numerical value is present by using a known text recognition technique.

In a case where a trigger is detected, a difference between vitality displayed in the gameplay video and maximum vitality in the match grasped in advance is calculated, and a numerical value as a ratio when a state in which the vitality is maximum is set to 1 can be set as the trigger detailed information.

As a method of calculating the difference, there is a method of creating a luminance binary image of display at the time of the maximum vitality in the match by using a threshold value th6, calculating a difference from an image obtained by performing similar processing on the pre-designated position of the video, and calculating a ratio of the difference at the time of the maximum vitality is 1. Furthermore, there is a method of obtaining a binary edge image of the gauge at the maximum vitality in the match by using a threshold value th7, calculating an area of a region surrounded by edges, then calculating a difference from an area of a region obtained by performing similar processing on the video, and calculating a ratio of a difference when the area at the time of maximum vitality is 1. Moreover, in a case where the vitality display is a numerical value instead of the gauge, there is a method of acquiring the vitality as a numerical value by using a known text recognition technology, and taking a ratio of the difference when the maximum vitality is 1. The trigger detailed information in this case indicates how much the vitality has decreased from the maximum vitality.

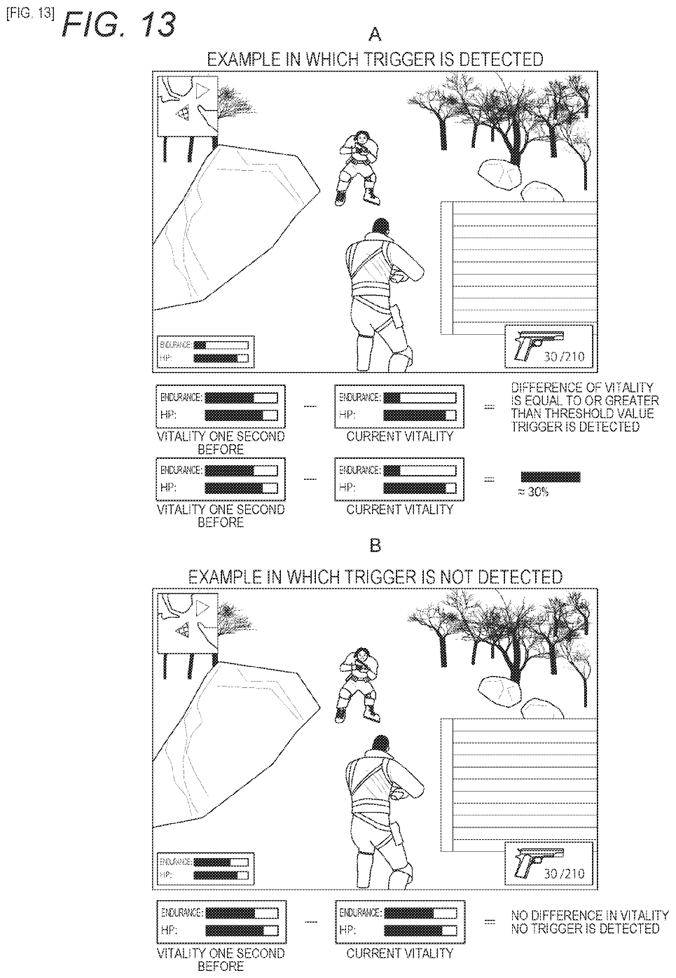

FIG. 13 is a specific example of a method of comparing current vitality with immediately preceding vitality, and detecting a trigger on the basis of whether or not a decrease amount in vitality is equal to or greater than a threshold value th8. The immediately preceding vitality is, for example, vitality one second before the current time, but this is merely an example, and the immediately preceding vitality may be designated with millisecond, the number of frames, or the like. In this trigger detection method, as illustrated in FIG. 13A, a value of the immediately preceding vitality is held in advance in the first information creation unit 103, the previous vitality is compared with the current vitality in the current gameplay video, and it is regarded that the trigger is detected in a case where a decrease amount is equal to or greater than the threshold value th8. A method of calculating the decrease amount is the same as the method described above. Whereas, as illustrated in FIG. 13B, it is regarded that the trigger is not detected in a case where the decrease amount is not equal to or greater than the threshold value th8 or there is no difference, when the immediately preceding vitality and the current vitality are compared.

The description returns to the flowchart of FIG. 8. In a case where a trigger is not detected, the processing ends without creating the trigger information (No in step S303).

Whereas, in a case where a trigger is detected, the processing proceeds from step S303 to step S304 (Yes in step S303).

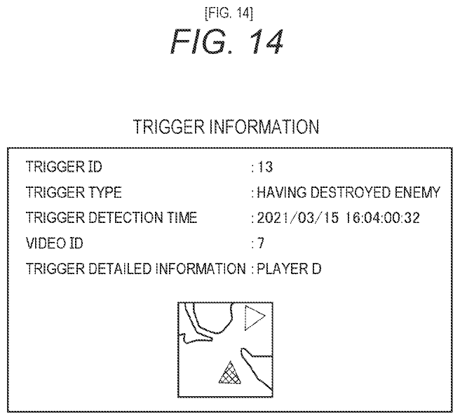

Next, in step S304, the first information creation unit 103 creates trigger information. As illustrated in FIG. 14, the trigger information includes at least: a trigger ID for uniquely identifying a trigger in the information storage unit 104 or the like; a trigger type indicating a type of the trigger; a trigger detection time; a video ID for identifying an input video in which the trigger has been detected; trigger detailed information; and a map image indicating a position on the game field included in the video at the time of detecting the trigger. The trigger detection time is a time at which an in-game instance detected as the trigger has occurred. The first information creation unit 103 creates the trigger information by collecting and associating these pieces of information with each other.

Note that, in a case where a plurality of triggers is detected, the first information creation unit 103 creates the trigger information for each of the plurality of triggers in step S304.

Next, in step S305, the first information creation unit 103 outputs the created trigger information to the information storage unit 104. The trigger information is stored in the information storage unit 104, and becomes a referable state in the event specifying processing.

Next, in step S306, the first information creation unit 103 holds the trigger information by itself such that the trigger information can be referred to in the event specifying processing.

As described above, the first information creation unit 103 performs the trigger detection processing.

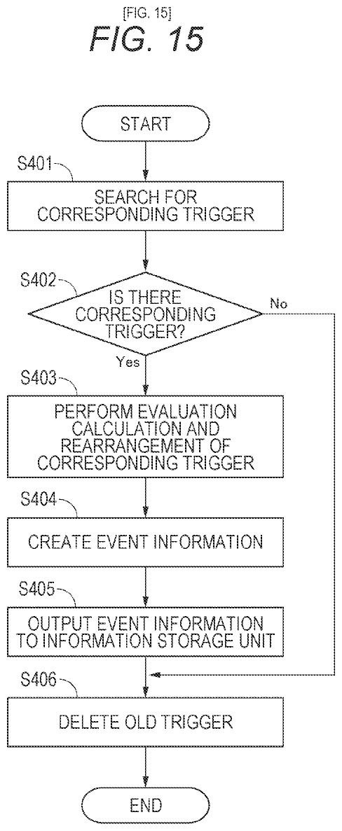

Next, the event specifying processing of step S204 will be described with reference to FIG. 15.

Note that, in a case where a plurality of triggers is detected in the trigger detection processing, the event specifying processing is performed for each of the plurality of triggers.

First, in step S401, for a target trigger that is a target of the event specifying processing among the plurality of detected triggers, a corresponding trigger within a past n [msec] is searched with reference to a current time or a detection time of the target trigger. The search is performed on the trigger information stored in the information storage unit 104 and the trigger information held in the first information creation unit 103. This n [msec] is a value set in advance, and has a role of correctly detecting the corresponding trigger by concealing an influence of communication time between with a game server, delay time of each input video received from a video source, time required for the trigger detection processing of each input video, and the like.

The corresponding trigger is a trigger corresponding to the target trigger other than the target trigger, among the plurality of detected triggers. For example, in a case where a trigger whose trigger type is “having destroyed an enemy” detected in a gameplay video of Player A is the target trigger, the corresponding trigger is a trigger whose trigger type is “being destroyed by an enemy (Player A)” in a gameplay video of another player. An event is constituted by a combination of the target trigger and the corresponding trigger.

Furthermore, in a case where a trigger whose trigger type is “being attacked by an enemy” detected in a gameplay video of Player B is the target trigger, the corresponding trigger is a trigger whose trigger type is “having attacked an enemy (Player B)” in a gameplay video of another player.

As described above, the target trigger and the corresponding trigger have a correspondence in which, for “one has an influence such as an attack on another”, “the another has an influence on the one”.

Furthermore, the trigger detailed information may be used to search for the corresponding trigger. For example, in a case where there is a name of a destroyed enemy player in the trigger detailed information of the trigger whose trigger type is “having destroyed an enemy”, the corresponding trigger can be searched by using the player name.

In a case where there is no corresponding trigger, the processing proceeds to step S406 (No in step S402). In this case, no event information is created. Whereas, in a case where there is a corresponding trigger, the processing proceeds to step S403 (Yes in step S402).

Next, in step S403, an evaluation value is calculated for the corresponding trigger, and the corresponding triggers are rearranged according to the evaluation value. The evaluation and rearrangement of the corresponding triggers are performed, for example, in order to more correctly estimate the correspondence between the target trigger and each corresponding trigger when a battle occurs simultaneously at a plurality of locations.

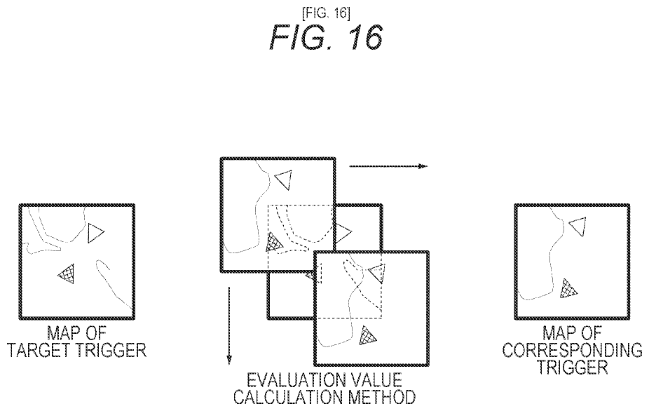

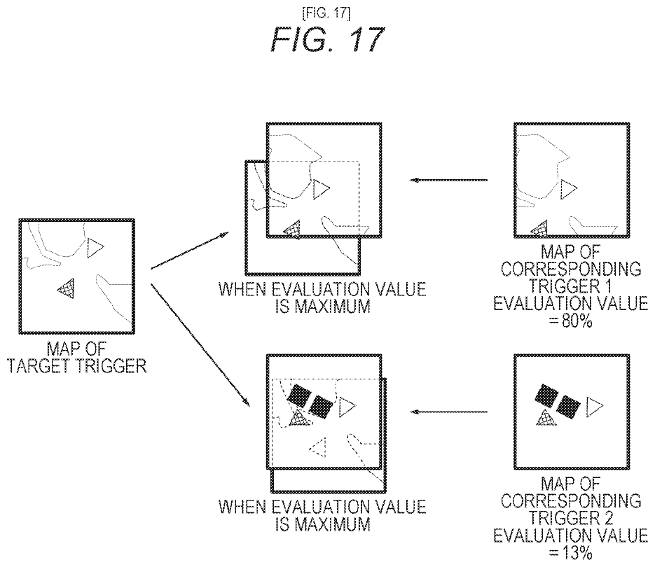

The evaluation value of the corresponding trigger can be calculated using map information indicating a position of each player on the game field as illustrated in FIGS. 16 and 17.

First, a binary edge image using a threshold value th9 is obtained for the map information included in the trigger information of the target trigger and the map information included in the trigger information of the corresponding trigger. Thereafter, as illustrated in FIG. 16, an edge image of the corresponding trigger is arranged on an edge of the target trigger while displacing vertically and horizontally by a certain size. A matching degree is obtained using, as a denominator, the number of edge pixels of the binary edge image of the target trigger in a region where the two edge images overlap with each other, and using, as a numerator, the number of edge pixels in which the two edge images are both edges in the overlapping region. This is repeatedly performed while changing an amount of vertical and horizontal displacement, and the maximum matching degree is set as the evaluation value of the corresponding trigger.

By using this method, a corresponding trigger closer in position to the target trigger has a higher evaluation value, and the correspondence between the target trigger and each corresponding trigger can be estimated more accurately, even when a plurality of corresponding triggers is detected at a time as illustrated in FIG. 17.

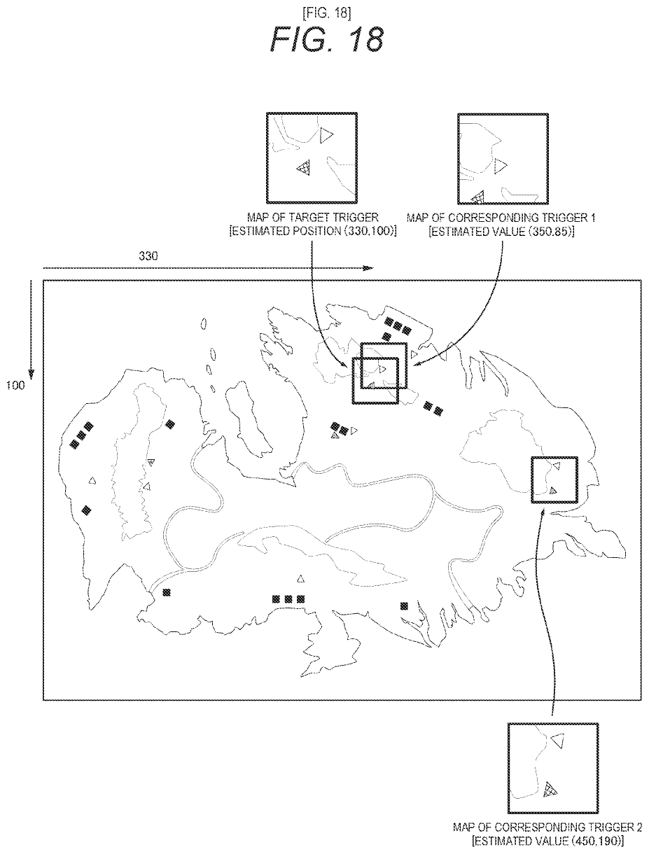

Furthermore, as illustrated in FIG. 18, there is also a method of calculating the evaluation value of the corresponding trigger by using a map video showing the entire game field. A binary edge image of a map video showing the entire game field is created by using a threshold value th10, a matching degree is obtained while an edge of each trigger obtained similarly is moved vertically and horizontally as illustrated in FIG. 16, and a position at a place where the matching degree becomes the maximum is set as an estimated position of the player, on the map image showing the entire game field. Then, using a distance to the estimated position of each trigger, it is possible to calculate an evaluation value in which a maximum distance that can be taken on the game field is used as a denominator and a value obtained by subtracting a distance between the target trigger and each corresponding trigger from the value of the denominator is used as a numerator.

Here, the specifying method by using edges is taken as an example. However, in addition to this, an evaluation value can also be obtained by calculating a scaled invariance feature transform feature amount (SIFT feature amount), a histograms of oriented gradients feature amount (HOG feature amount), and the like for each map image or video, setting a square sum of a feature amount included in the detection trigger as a denominator, and setting, as a numerator, a value obtained by subtracting, from the value of the denominator, a square sum of a value obtained by subtracting a feature amount included in the corresponding trigger from the feature amount included in the detection trigger.

After the evaluation value of each corresponding trigger is calculated, the corresponding triggers are rearranged in descending order of the evaluation value.

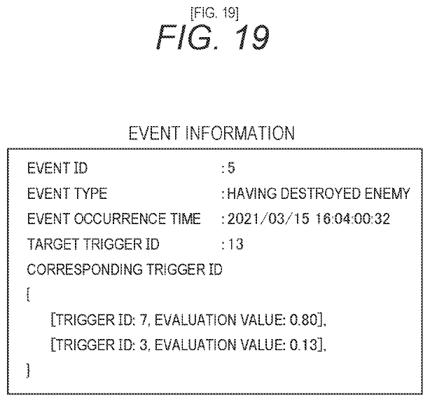

Next, in step S404, the first information creation unit 103 creates event information on the basis of the trigger information. As illustrated in FIG. 19, the event information includes at least: an event ID for uniquely identifying event information in the information storage unit 104 or the like; an event type indicating a type of the event; event occurrence time; a target trigger ID and a corresponding trigger ID for identifying the target trigger and the corresponding trigger constituting the event; and an evaluation value of the corresponding trigger. The first information creation unit 103 creates event information by collecting and associating these pieces of information with each other. The event occurrence time is a time at which an in-game instance detected as the trigger has occurred.

Next, in step S405, the first information creation unit 103 outputs the event information to the information storage unit 104.

Then, in step S406, among the trigger information held in the first information creation unit 103, trigger information whose detection time is older than the past n [msec] with the current time as a reference is deleted. This is because the trigger information older than the past n [msec] is unnecessary at the time of creating the event information.

The event specifying processing is performed as described above. By the processing of the first information creation unit 103, for example, in a case where an instance of “having attacked” is detected as a trigger and set as the target trigger, an instance of “being attacked” is detected as the corresponding trigger, and event information including the target trigger and the corresponding trigger is created, so that a player who has been attacked can be specified and estimated simultaneously with specifying of a player who has attacked.

### [1-3-4. Processing in Second Information Creation Unit 105]

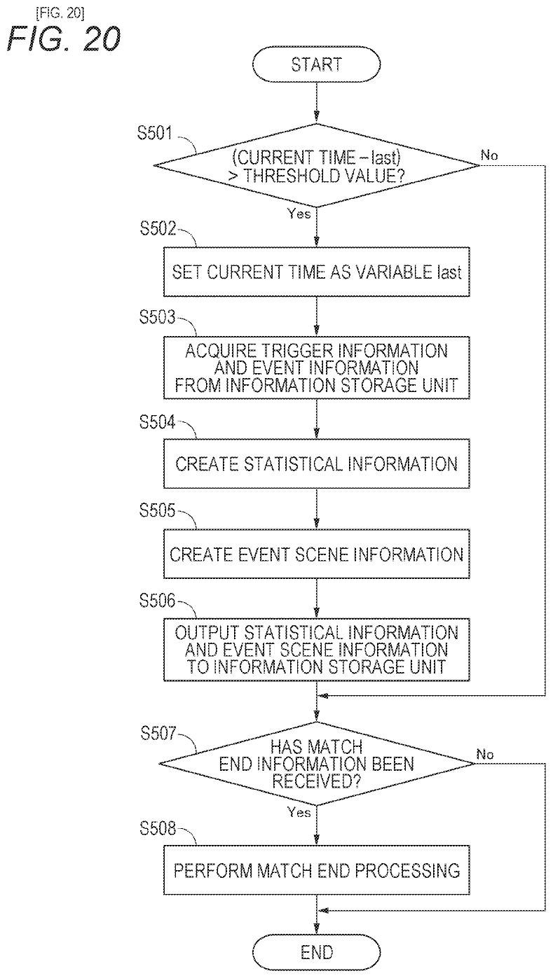

Next, processing in the second information creation unit 105 will be described with reference to FIG. 20.

First, in step S501, it is determined whether a value obtained by subtracting a variable “last” from a current time is equal to or greater than a threshold value th11, and in a case where the value is equal to or greater than the threshold value th11, the processing proceeds to step S502 (Yes in step S501). An initial value of the variable “last” is set to 0.

Next, in step S502, the current time is set as the variable “last”. Steps S501 and S502 are for determining whether or not a certain time period has elapsed since steps S503 to S506 have been performed in the previous processing. This is because, due to a property of the processing of the second information creation unit 105, the processing from step S503 to step S506 may be always executed, or may be executed every certain number of seconds from a start of the match by determining the number of seconds or the like in advance.

Next, in step S503, trigger information and event information regarding a match currently being performed are acquired from the information storage unit 104. Specifically, the trigger information is acquired whose trigger detection time is after a time at which the trigger information and the event information have been previously acquired from the information storage unit 104, and event information is acquired whose event occurrence time is after a time at which the trigger information and the event information have been previously acquired from the previous information storage unit 104. Note that since the acquired trigger information and event information are referred to in subsequent processing, the acquired trigger information and event information are held in the second information creation unit 105 only for a preset period and can be freely referred to.

Next, in step S504, the second information creation unit 105 creates statistical information from the acquired trigger information and event information. The statistical information is, for example, the number of times of detection of a trigger for every trigger type in a match, the number of times of detection of a trigger for each player, the number of times of detection of a trigger for every trigger type, and the like, but is not limited thereto.

In a case of creating the statistical information based on the player, the creation can be realized by acquiring a player name included as the trigger detailed information in the trigger information and a player name included in video information that can be specified by the video ID included in the trigger information. By creating the statistical information from the trigger information, the event information, and the video information, it is possible to obtain information such as how much which player has been involved in the event, and the information can be used in the video creation in the video processing unit 106. The created statistical information is held in the second information creation unit 105.

Next, in step S505, the event scene information is created using the trigger information and the event information held in the second information creation unit 105 and the trigger information and the event information stored in the information storage unit 104. The creation of the event scene information will be described later. Note that the event scene information is created in a case where there is an event scene that achieves an event scene condition. The event scene is a temporal section that includes a plurality of events, and is an excitement scene, a highlight scene, or the like of a match. The event scene condition is a condition that includes a predetermined threshold value, a conditional statement, and the like, and is to determine whether or not to be sufficient as the event scene. Details of the event scene information and event scene information creation will be described later.

Next, in step S506, the second information creation unit 105 outputs the created statistical information and event scene information to the information storage unit 104. At that time, a part of the output statistical information and the event scene information may be held in the second information creation unit 105, and used in the processing of the second information creation unit 105 next time. For example, by holding a total number of times of trigger detection which is the statistical information, and adding the number of times of the trigger detection processing for new detection to the held total number of times of trigger detection when the statistical information is again calculated next time, the processing time can be reduced.

Next, in step S507, it is determined whether or not the match end information has been received from the pre-processing unit 101. In a case where the match end information has been received, the processing proceeds to step S508 (Yes in step S507), and the match end processing is performed. As the match end processing, the trigger information, the event information, the statistical information, and the like held in the second information creation unit 105 are deleted to avoid influence of information about the previous match when information about the next match is input.

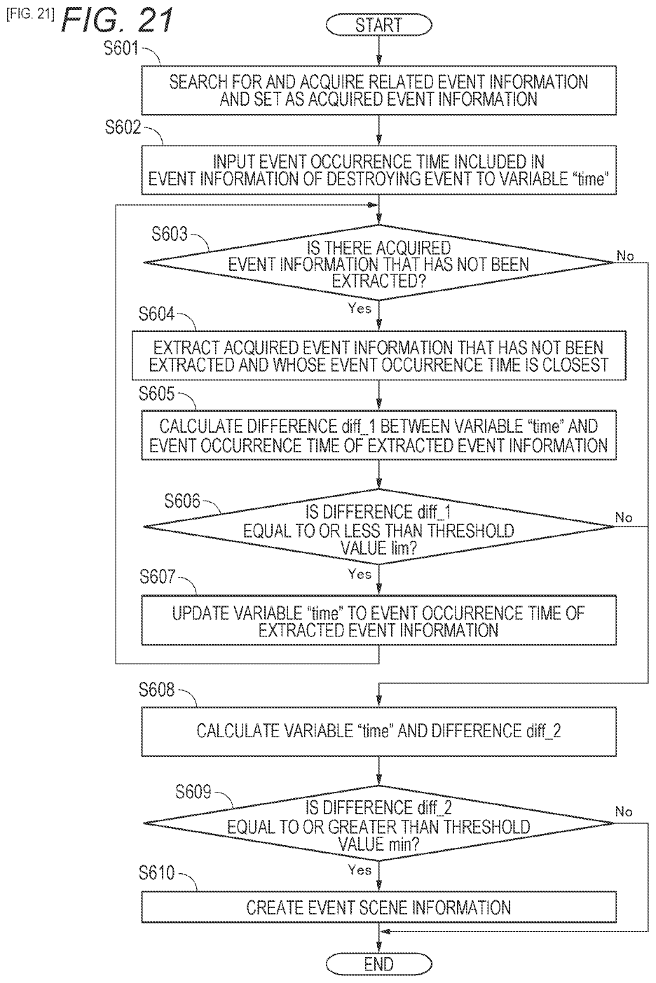

Here, the event scene information creation in step S505 will be described with reference to FIG. 21.

Here, a case will be described as an example in which the second information creation unit 105 acquires, in step S503, event information (referred to as destroying event information) having the event type of “Player A has destroyed Player B”. This method can be generalized more, and an event scene can be created every time event information having the event type of “having destroyed an enemy” or “being destroyed by an enemy” is received.

First, in step S601, event information related to Player A and Player B generated within a past s [msec] from an event occurrence time included in the destroying event information is searched and acquired. The search is performed on the event information stored in the information storage unit 104 and the event information stored in the second information creation unit 105. Here, s [msec] is a value set in advance, and indicates a maximum section length of the event scene.

The event information related to Player A and Player B is the event information in which a player name included in video information that can be specified by the video ID included in the trigger information is Player A or Player B, when trigger information that can be specified by the target trigger ID included in the event information is referred to. Furthermore, at that time, the trigger detailed information of the trigger information that can be specified by the target trigger ID may be referred to. There may be one or a plurality of pieces of related event information. The acquired event information is hereinafter referred to as acquired event information.

Steps S602 to S607 are processing of extracting the event information one piece by one piece from the acquired event information, and determining whether to include the event information in the event scene.

Next, in step S602, the event occurrence time included in the destroying event information is set as a variable “time”.

Next, in a case where there is acquired event information that has not yet been extracted in step S603, the processing proceeds to step S604 (Yes in step S603). Whereas, in a case where there is no acquired event information that has not been extracted or the number of search results is 0, the processing proceeds to step S608 (No in step S603).

Next, in step S604, the event information whose event occurrence time is closest to the current time is extracted, from among the acquired event information that has not been extracted. Note that the extraction processing is different from the acquisition processing. Next, in step S605, a difference diff_1 between the variable “time” and the event occurrence time closest to the current time is calculated.

In a case where the difference diff_1 is equal to or less than a preset threshold value lim, the processing proceeds to step S607 (Yes in step S606). The threshold value lim is a reference value for determining whether to include the extracted event information in the event scene. In a case where the difference diff_1 is equal to or less than the threshold value lim, it is determined that the extracted event information should be included in the event scene.

Next, in step S607, a value of the variable “time” is updated to the event occurrence time of the extracted event information. Then, the processing returns to step S603. Whereas, in a case where the difference diff_1 is not equal to or less than the threshold value lim, the processing proceeds to step S608 (No in step S606).

Next, in step S608, a difference diff_2 is calculated between the event occurrence time of the destroying event information and the oldest event occurrence time among the event occurrence times included in the event information determined to be included in the event scene, up to step S607. In a case where there is no event information determined to be included in the event scene, 0 is set to the difference diff_2. A threshold value min indicates a minimum section length recognized as an event scene.

Then, in step S609, it is determined whether or not the difference diff_2 is equal to or greater than the threshold value min. In a case where the difference diff_2 is equal to or greater than the threshold value min, the processing proceeds to step S610 (Yes in step S609).

Then, in step S610, the second information creation unit 105 creates event scene information.

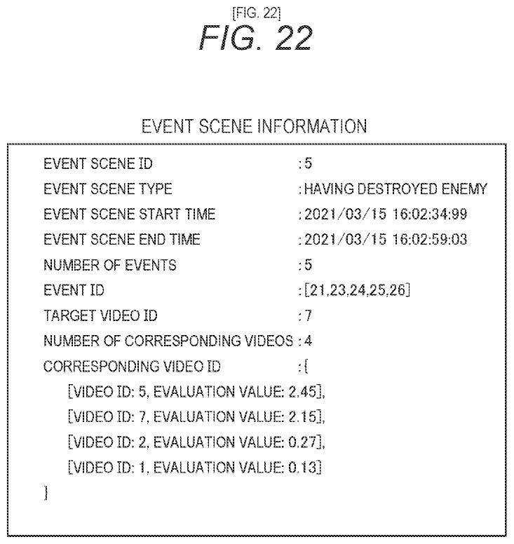

The event scene information is created so as to include information illustrated in FIG. 22. An event scene ID is an ID for uniquely identifying event scene information in the information storage unit 104 or the like. An event scene type indicates what the event scene is. Here, the event scene information is created for a case where the destroying event information is acquired, so that the event scene type is “having destroyed an enemy”.

An event scene start time is the oldest event occurrence time among the event occurrence times of the event information proved as the event information that should be included in the event scene up to step S607. An event scene end time is an event occurrence time of the acquired event information whose event type is “having destroyed an enemy”. Furthermore, the number of events and the event ID are the number of pieces of event information proved as the event information that should be included in the event scene up to step S607 and the event ID of the event information.

In the event scene information created when certain event information is acquired, the target video ID is the video ID included in trigger information that can be specified by the trigger ID included in the certain event information. Corresponding video IDs are a plurality of video IDs included in trigger information that can be specified by corresponding trigger IDs included in the certain event information or event information proved as the event information that should be included in the event scene up to step S607. In this description, since the destroying event information corresponds to the certain event information, the target video ID is the video ID included in the trigger information that can be specified by the trigger ID included in the destruction event information. Note that the corresponding video IDs are a plurality of video IDs including the target video ID. This is because unless the battle is unilateral, an event of attacking the enemy and an event of being attacked by the enemy mutually occur.

The number of corresponding videos is the number of corresponding videos included in the event scene. The evaluation value for every video ID indicates a degree of involvement of an input video in the event scene. For example, in the example of FIG. 22, for example, since a video ID 5 has a higher evaluation value than video IDs other than the target video ID, it can be estimated that a player corresponding to a video ID 7 has highly possibly destroyed a player corresponding to the video ID 5.

Furthermore, in the example of FIG. 22, it can be estimated that the evaluation values of a video ID1 and a video ID2 are obviously lower than the evaluation values of other video IDs, and can be highly possibly estimated as unrelated video IDs that are not involved in the event scene in considering with the evaluation value calculation method of the event information exemplified this time.

The evaluation value of the corresponding video ID can be obtained as follows, for example. First, all the corresponding trigger IDs included in the event information that should be included in the event scene and the evaluation values thereof (those illustrated in FIG. 19) are acquired, and the evaluation value of the corresponding trigger is weighted on the basis of the event occurrence time included in the event information that should be included in the event scene.

For example, the evaluation value of the corresponding trigger included in the event information having the latest event occurrence time is multiplied by 1, the evaluation value of the corresponding trigger included in the event information having the second latest event occurrence time is multiplied by 0.9, and the evaluation value of the corresponding trigger included in the event information having the third latest event occurrence time is multiplied by 0.8. Thereafter, all the corresponding trigger IDs included in the event information that should be included in the event scene are converted into video IDs included in the trigger information that can be specified by the corresponding trigger IDs, the evaluation values are summed for every video ID and arranged in descending order by the evaluation value, and a set of the corresponding video ID and the evaluation value is obtained.

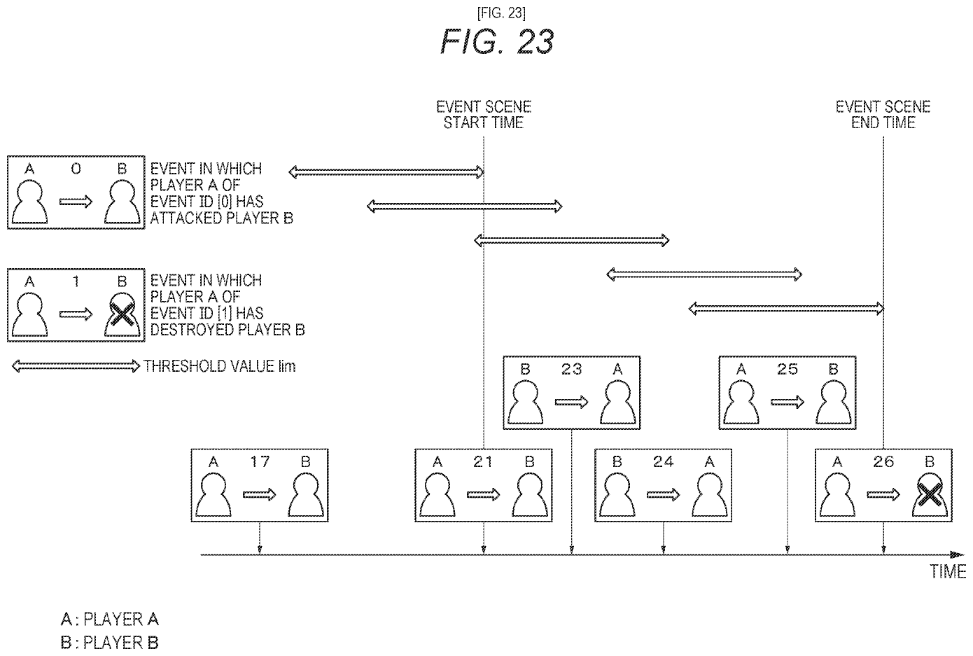

FIG. 23 is an example in which the acquired event information is arranged in time series, and illustrates the flow from step S603 to step S607 and an event scene start time and an event scene end time. An event ID 17 having the event occurrence time farther than a time obtained by subtracting the threshold value lim from the event occurrence time of an event ID 21 is not included in the event scene since the event ID 17 does not significantly affect the event scene to be created. By doing this way, unnecessary time of the event scene can be eliminated, and the event scene can be created for a more exciting scene.

Here, the creation of the event scene information in a case where the event information of the case of having destroyed an enemy is acquired has been described. However, without limiting to this, for example, a section in which a large amount of trigger information related to a certain player is detected within a certain time period can be set as the event scene.

Note that, in addition to the above-described processing, the second information creation unit 105 can create information and organize information considered to be necessary for the video processing unit 106. For example, in the event type included in the event information, it is also possible to change the event type of “being attacked by an enemy” to the event type of “having attacked an enemy”, and replace the corresponding trigger ID having the highest evaluation value with the target trigger ID and replace the original target trigger ID with the corresponding trigger ID having the maximum evaluation value. In such a way, by reducing variations of event types, and associating the video ID included in the trigger information that can be designated by the target trigger ID with the player who has attacked, and the video ID included in the trigger information that can be designated by the corresponding trigger ID with the player who has been attacked, the processing of the video processing unit 106 can be made more efficient. In particular, it is possible to reduce a possibility that a person misunderstands the correspondence in the event at a stage of determining a video creation method to be described later.

### [1-3-5. Processing in Video Processing Unit 106]

Next, processing in the video processing unit 106 will be described.

By using an input video acquired from the video storage unit 102, trigger information event information, statistical information, and event scene information which are video creation information acquired from the information storage unit 104, the video processing unit 106 determines a video (material video) to be associated with creation of an output video from the input video, and creates the output video by using the material video. For example, in a case where there are five players, there are a total of ten input videos including at least five gameplay videos and five player videos, and the video processing unit 106 determines which of the ten videos is to be used as the material video, and creates the output video by using the material video.

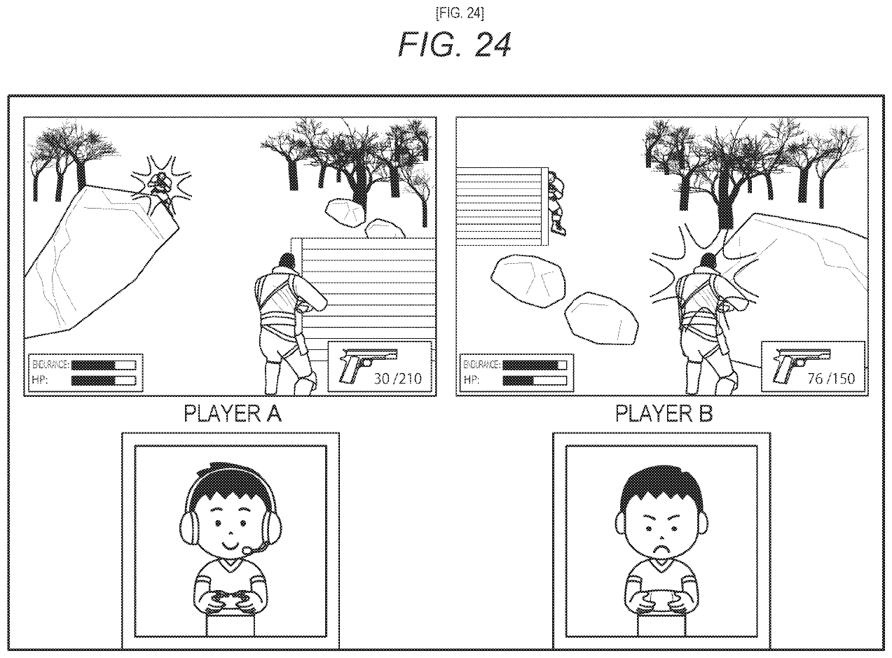

A video creation method includes arrangement information indicating where and what is to be arranged in the output video, and a determination method for a video ID to be associated with creation of the output video. FIGS. 24, 25, and 26 are examples of the created output video.

FIG. 24 illustrates an example of an output video created using event information and trigger information. The output video is created by acquiring most recent event information including the event type of “having attacked an enemy” and one corresponding trigger ID for one target trigger, and arranging gameplay videos and player videos of two players on the basis of the event information.

In the example of FIG. 24, the output video includes an upper stage, a middle stage, and a lower stage. The gameplay videos of individual players are arranged on the left and right in the upper stage, the player videos of the players corresponding to the gameplay videos in the upper stage are arranged in the lower stage, and individual player names are arranged in the middle stage.

A video ID of the gameplay video arranged on the upper left side is the video ID included in the trigger information that can be specified by the target trigger ID included in the most recent event information. Furthermore, a video ID of the player video arranged on the lower left side is a video ID of a video showing the same player as the video on the upper left side. The player name can be confirmed by a player name included in video information that can be specified by the video ID included in the trigger information. As described above, the video processing unit 106 determines, as the material video, the input video that can be specified by the video ID included in the trigger information.

A video ID of the gameplay video arranged on the upper right side is the video ID included in the trigger information that can be specified by a corresponding trigger ID having the highest evaluation value in the most recent event information. A video ID of the video on the lower right side is a video ID of a video showing the same player as the video on the upper right side. As described above, the video processing unit 106 determines, as the material video, the input video that can be specified by the video ID included in the trigger information that can be specified by the trigger ID of the event information.

Text on the left side of the middle stage is the player name corresponding to the video displayed in a left side portion of the output video, and text on the right side of the middle stage is the player name corresponding to the video displayed in a right side portion of the output video.

By using the most recent event information, it is possible to instantaneously identify who and who are currently fighting. Therefore, by specifying the video IDs of the gameplay video and the player video of the player who is attacking and the gameplay video and the player video of the player who is being attacked, these videos can be included as the material videos in one output video. As a result, it is possible to create an output video expressing a situation where which side will win is unknown. Such a video creation method can also be applied to a situation where there is a plurality of corresponding trigger IDs but there is only one video ID having an evaluation value equal to or greater than a preset threshold value th12, or a video ID having the highest evaluation value can be adopted.

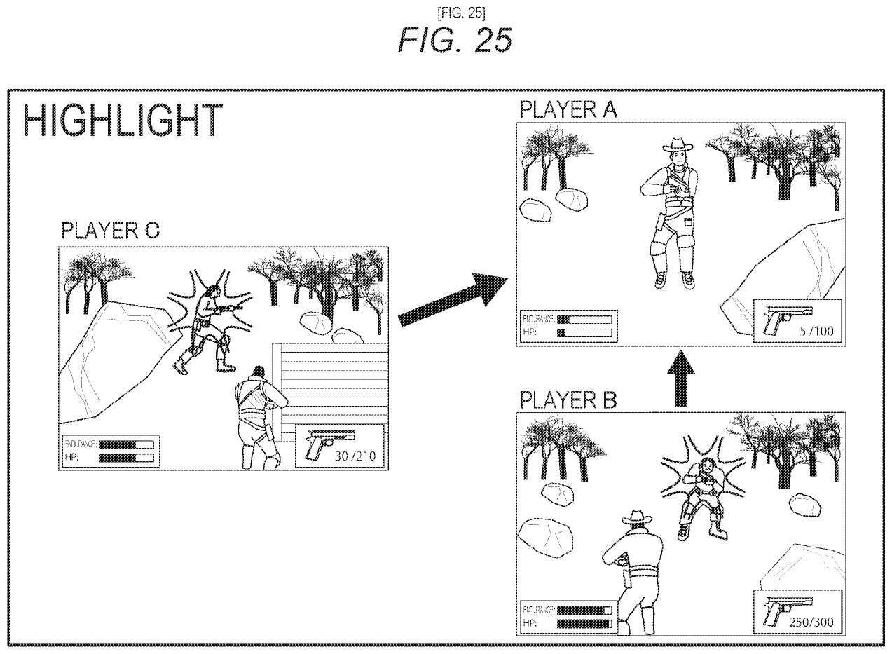

FIG. 25 illustrates an example of an output video created using event scene information. Specifically, it is an example of an output video created using event scene information having the event scene type of “being destroyed by an enemy”. This example is useful in creating an output video for providing an enemy destroying video in a match as a highlight, after the match.

This output video is an output video in a case where, except for the target video ID, there are two video IDs each of which is the corresponding video ID included in the event scene information and has the evaluation value equal to or greater than the threshold value th12.

The corresponding video ID included in the event scene information whose event scene type is “being destroyed by an enemy” includes the gameplay video of a player who has destroyed. Furthermore, the fact that there are two video IDs with evaluation values equal to or greater than the threshold value th12 other than the target video ID means that there are two players who have attacked the destroyed player. Therefore, the output video in which one player is attacked by two players can be created using these video IDs. As described above, the video processing unit 106 determines, as the material video, the input video that can be specified by the video ID included in the event scene information.

Furthermore, by using the method of evaluation value calculation for the corresponding trigger using the map video indicating a position of each video on the game field as illustrated in FIG. 18, a positional relationship can be calculated by performing position estimation instead of evaluation value calculation, and the calculation result can be reflected in the creation of the output video.

Specifically, as illustrated in FIG. 25, it is possible to determine the arrangement information by reflecting a positional relationship of players and arrange the gameplay video, or create the output video in which Player B who is closest is selected and displayed. Examples of the determination method for the video ID in the video creation method used to create the output video of FIG. 25 include the methods described above.

The arrangement information can be set by a plurality of functions. A first function is a function for arrangement at a position matching the position information on the output video, by inputting the position information of the corresponding video ID and the target video ID whose evaluation value in the event scene information is equal to or greater than a threshold value th13. A second function is a function for outputting a figure corresponding to an event scene type, for example, such as extending an arrow from a video of attacking to a video of being attacked, by inputting an event scene type in the event scene information, information indicating whether each video is the target video or the corresponding video, and position information on a created video of each video.

Furthermore, by creating an output video from a time a constant number of seconds before the event scene start time of the event scene information to a time a constant number of seconds after the event scene end time, it is possible to secure time for understanding what the video indicates, when the video is provided to the viewer as a highlight.

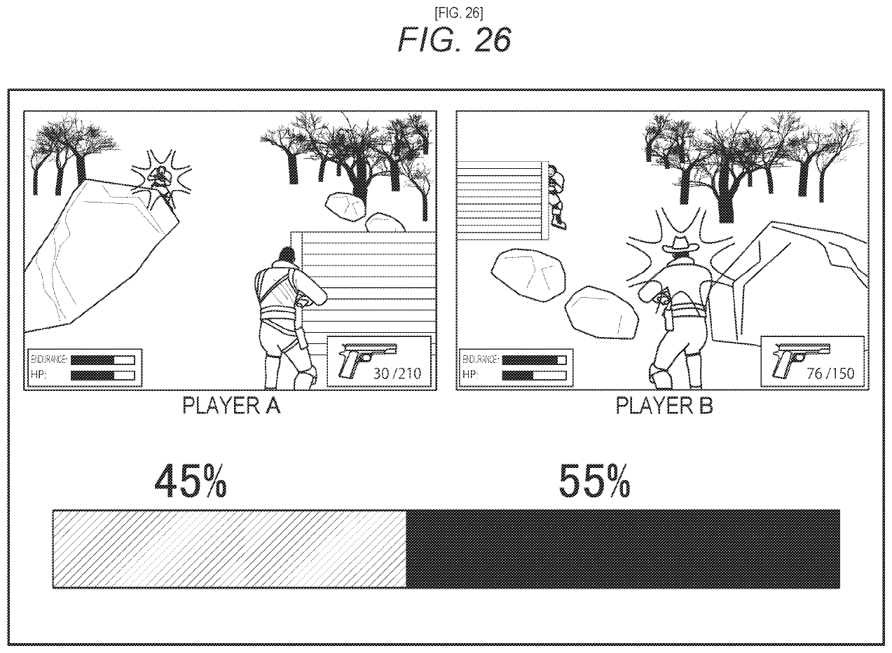

FIG. 26 illustrates a creation example of an output video using trigger information. In the arrangement information and the video ID determination method of this video creation method, an upper part is the same as that in the upper state of FIG. 24. In the example of FIG. 26, a gauge indicating vitality of a player corresponding to each gameplay video arranged in the upper part is arranged in a lower stage, and a player name corresponding to each gameplay video arranged in the upper stage is arranged in a middle stage.

The lower stage is for calculating and expressing current vitality of each player in a graph, by using “a difference between maximum vitality and current vitality”, which is the trigger detailed information in a case where the trigger type is “having attacked an enemy” as described with reference to FIG. 9. By updating a numerical value and video expression each time the trigger of each player is detected, superiority and inferiority of a battle situation can be represented for every trigger.

When and which video creation method is used to create the output video may be determined by preparing a plurality of video creation methods in advance and allowing a person to browse each piece of information, or may be automatically determined by setting a condition or the like in advance. As the condition for determining the video creation method, information obtained from trigger information, event information, event scene information, statistical information, or the like can be used.

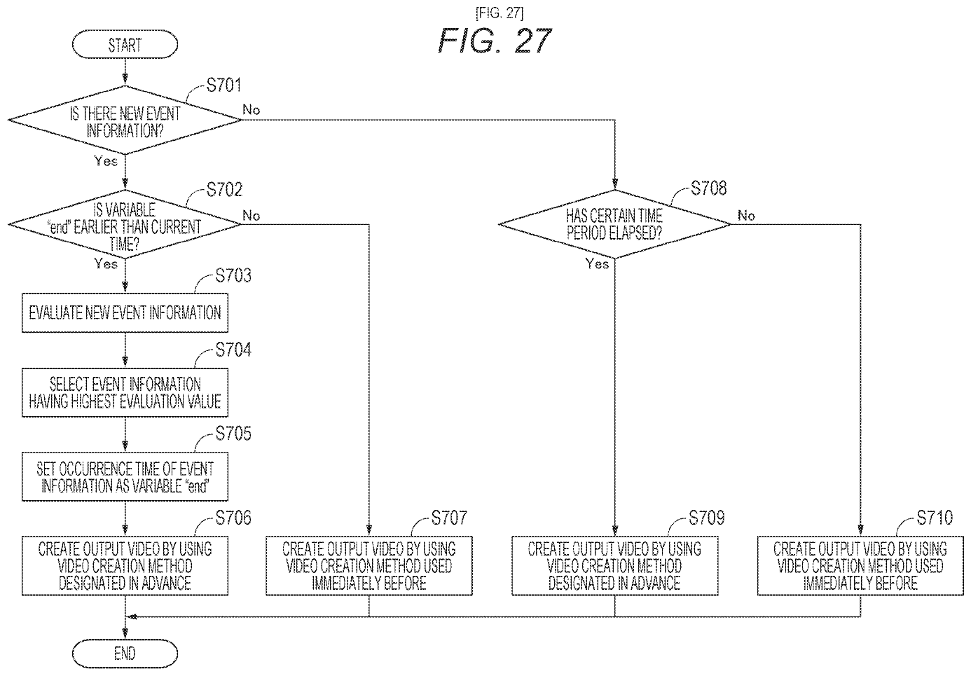

A template of the video creation method as illustrated in FIGS. 24 to 26 is prepared in advance, and the video processing unit 106 creates an output video by using any one of the templates. FIG. 27 is an example of processing in which the video processing unit 106 automatically determines the video creation method. By periodically executing this processing at a short interval such as several milliseconds, it is possible to appropriately determine the video creation method and create an output video according to the method.

First, in step S701, whether or not new event information has been created after the previous output video creation is checked with reference to event information held by the first information creation unit 103 and event information stored in the information storage unit 104. In a case where new event information has been created, the processing proceeds to step S702 (Yes in step S701).

Next, in step S702, it is determined whether a time set as a variable “end” is earlier than the current time. The variable “end” means a time until which the output video created by the video setting method is continued in a situation where the video creation method is determined on the basis of the event information. In a case where the variable “end” is earlier than the current time, the processing proceeds to step S703 (Yes in step S702).

Next, in step S703, an evaluation value is calculated for the new event information. This is particularly effective in a case of presence of a plurality of pieces of new event information. This evaluation value is a numerical value from 0 to 1, which is an index in a case of selecting event information to which the output video to be created is related. This evaluation value can be set by combining conditional statements that can be created using information such as trigger information, event information, statistical information, and a video ID used in the video creation method used immediately before.

For example, in a case where the video ID used in the video creation method used immediately before matches the video ID included in trigger information that can be specified by the target trigger ID included in the event information or the video ID included in trigger information that can be specified by the corresponding trigger ID, the evaluation value is set to 1. Furthermore, video information may be specified using the video ID from the trigger information that can be specified by the target trigger ID, and a value obtained by dividing the number of times of trigger occurrence of the player so far by a total number of times of trigger occurrence may be used as an evaluation value, by using the player name included in the video information. Furthermore, the evaluation values may be set to 1, 0.8, 0.6, . . . in ascending order of the occurrence time in the event information. Furthermore, an evaluation value according to an event type may be set. Moreover, a weighted integration of evaluation values calculated under the above-described conditions may be used as the evaluation value. Note that the examples of these evaluation values are merely examples, and the evaluation values are not limited thereto.

Next, in step S704, event information having the highest evaluation value calculated in step S703 is selected.

Next, in step S705, preset constant seconds are added to the event occurrence time of the event information selected in step S704, and this is set as the variable “end”.

Next, in step S706, a new output video is created by a video creation method designated in advance, by using the event information selected in step S704. In a case where the video creation method of FIG. 24 is designated in advance in a state where there are the video creation methods illustrated in FIGS. 24 to 26, the output video is created by the video creation method of FIG. 24.

The description returns to step S702. In step S702, in a case where a time set as the variable “end” is not earlier than the current time, the processing proceeds to step S707 (No in step S702). Then, in step S707, the video creation method used in the output video creation immediately before is continuously used to create an output video.

The description returns to step S701. In a case where new event information has not been created since the previous output video creation in step S701, the processing proceeds to step S708 (No in step S701).

Next, in step S708, it is determined whether the output video created by the video creation method used in the output video creation immediately before continues for a preset time period or more. The preset time period indicates a minimum time period for continuously outputting, to the viewer, the output video created by the same video creation method. By setting this time period, it is possible to avoid a situation where the output video to be created changes rapidly with time.

In a case where the output video created by the video creation method used in the output video creation immediately before continues for the preset time period or more, the processing proceeds to step S709 (Yes in step S708). Then, in step S709, a new output video is created by a video creation method designated in advance. As the video creation method designated in advance in step S709, for example, there is a method of randomly designating one video ID and outputting a video that can be specified by the video ID as it is as the output video.

Whereas, in a case where the video created by the video creation method used in the output video creation immediately before is not continued for the preset time period or more in step S708, the processing proceeds to step S710 (No in step S708).

Then, in step S710, the video creation method used in the output video creation immediately before is continuously used to create the output video.

Note that the video processing unit 106 may determine a template for video creation on the basis of the number of corresponding triggers.

In the processing of FIG. 27, one video creation method is designated in advance in step S706 or step S709, but a plurality of video creation methods can be designated in advance by further adding a condition. For example, in step S706, the video creation method as illustrated in FIG. 26 and the video creation method as illustrated in FIG. 24 can be randomly selected.

In the video creation method set in the processing of FIG. 27, as the video creation method selected immediately before, the video processing unit 106 holds the video creation method by using a storage device or the like to enable the video creation method to be referred to.

Note that the processing of the video processing unit 106 may be started after a lapse of a certain time period from the start of the match. That is, a delay of a certain time period may be provided between the match start time and the video creation start time. By providing this delay, event scene information that has been used to determine a video to be distributed after the match can be used. As a result, it is possible to improve a situation where the video creation method is switched even for event information that is not included certainly in the event scene information, and it is possible to create the output video certainly including a scene in which a change has occurred in the match. Specifically, processing can be performed such that the event information in FIG. 27 is replaced with the event scene information, and a value obtained by adding constant seconds to the event scene end time in the event scene information is substituted to a value of the variable “end”.

Note that a person may operate a personal computer or the like as the video processing apparatus 100 to determine arrangement or the like of the material video in the output video by drag and drop or the like, and the video processing unit 106 may create the output video on the basis of the arrangement or the like.

The processing in the first embodiment is performed as described above. In the first embodiment, the first information creation unit 103 and the second information creation unit 105 create trigger information, event information, event scene information, and statistical information as video creation information, which are created by the video processing unit 106. Then, on the basis of these pieces of information, an instance corresponding to a certain instance is specified in a form of a trigger and an event in a plurality of input videos, and an output video is created so as to include these instances. As a result, a range of the output video is widened, an output video that makes the viewer feel more pleasant can be created, and a situation where who will win is unknown can be represented to the viewer. Furthermore, it is possible to represent a sense of tension such as “which will win” and to further enliven the viewer with the output video.

Furthermore, according to the present technology, it is possible to create an output video in which it is easy to recognize which player and which player are involved (fighting) in accordance with a relationship between the target trigger and the corresponding trigger. As a result, the viewer can easily understand which player and which player are involved (fighting). Moreover, it is possible to specify which player is involved in the event by using the trigger included in the event information, and create the output video so as to include the video of the player involved in the event.

Furthermore, according to the present technology, an organizer or the like side grasps which player and which player are involved (fighting), which serves as a determination material when the output video is done, and an output video that attracts more viewers can be created.

Moreover, by using the event information, it is possible to express information about a player involved in the event, a player who has made a greater attack, and the like by using numerical values, and it is possible to visually represent how much each player has worked hard, to the viewer. It is possible to show the viewer videos of two players in advance in which a battle is likely to occur, and when the battle actually occurs, it is possible to create an output video including a state of the battle from the beginning to the end, and to provide the output video without missing a timing of excitement.

### 2. Second Embodiment

### [2-1. Premises]

Next, a second embodiment of the present technology is described.

The first embodiment has been based on the premise that gameplay videos of all players participating in a match can be simultaneously obtained, so that it has been easy to find a corresponding trigger and it has been possible to create event information.

However, it is difficult to prepare such an environment. In practice, in a game tournament or the like in which a video is provided to a viewer, there are many cases where an output video is created on the basis of limited videos such as a gameplay video or the like of several players provided by a game server, and the output video is provided to viewers.

Therefore, the second embodiment proposes a mechanism that can determine a material video to be associated with creation of an output video and estimate which player's video the material video belongs to, even in such a limited situation.

In the second embodiment, a situation is considered in which only gameplay videos of up to P players can be simultaneously acquired. P is a value smaller than a total number of players participating in one match. This indicates a situation where a player name does not uniquely correspond to a video ID. More specifically, a state is assumed in which, in a situation where gameplay videos of several players are input from various video sources, it is necessary to switch which player's gameplay video is received in real time, and the switching is performed on videos corresponding to one video ID.

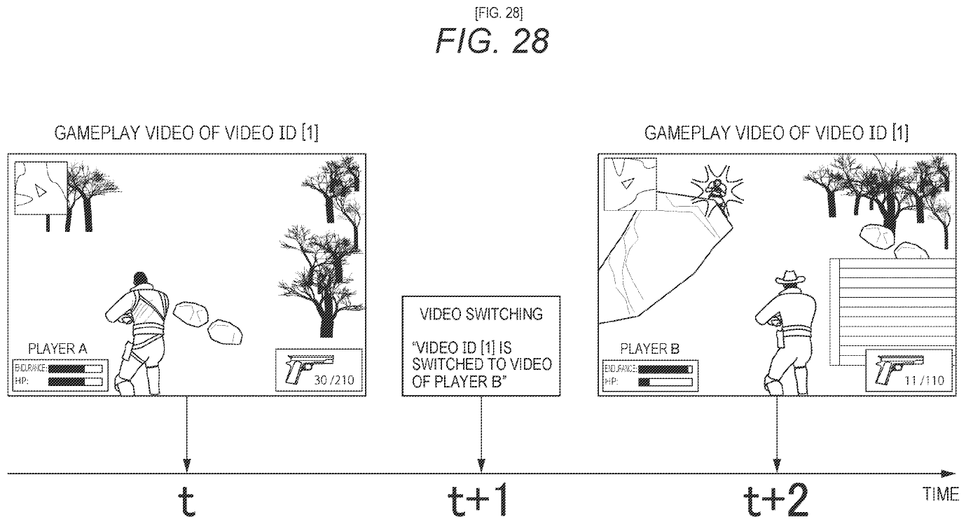

FIG. 28 illustrates switching of a video in such a situation. FIG. 28 illustrates a case where an input video is a gameplay video (video ID [1]) and the organizer or the like switches the gameplay video of the video ID [1] from a gameplay video of Player A to a gameplay video of Player B at time t+1. Although the player corresponding to the gameplay video is changed, the video ID of the gameplay video of Player A at time t and the video ID of the gameplay video of Player B at time t+2 are the same.

### [2-2. Processing in Video Processing Apparatus 100]

Next, processing in a video processing apparatus 100 according to the second embodiment will be described. Similarly to the first embodiment, the video processing apparatus 100 includes a pre-processing unit 101, a video storage unit 102, a first information creation unit 103, an information storage unit 104, a second information creation unit 105, and a video processing unit 106.

A player name is included in video information to be associated with each input video by the pre-processing unit 101. However, in the second embodiment, which player's gameplay video each input video belongs to is specified by analyzing the input video.

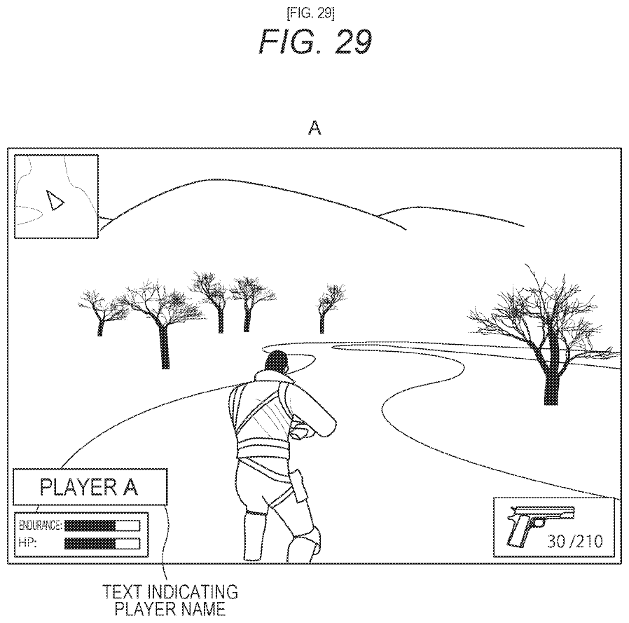

FIG. 29 is an example of a gameplay video in the situation of the second embodiment. In the second embodiment, it is assumed that text and a numerical value such as a player name indicating which player's gameplay video the gameplay video belongs to are always displayed in the gameplay video.

By designating a text detection region in advance in the gameplay video, and specifying a player name by recognizing the text by using a known text recognition technique or the like, which player's gameplay video the gameplay video belongs to is specified, and a player name as video information is associated with the input video. If the player name cannot be specified at the time of player switching or when an object or the like in the gameplay video is overlapped with the text detection region by other processing in the game, it is possible to take a measure such as leaving the player name blank or making the player name the same as the player name immediately before.

Note that a display position of the text indicating the player name is not limited to the position illustrated in FIG. 29, and may be anywhere as long as the text is displayed in the gameplay video.

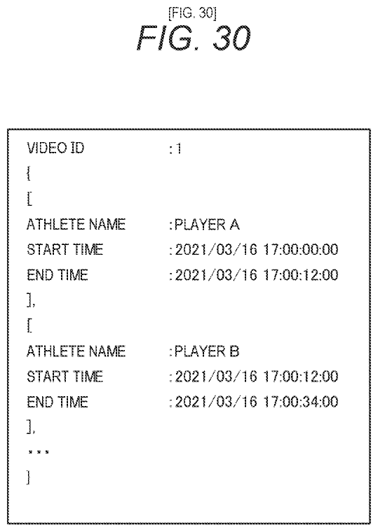

In the pre-processing unit 101, information indicating which section of the gameplay video is the gameplay video of which player is associated with the video ID associated with the gameplay video as video information, as illustrated in FIG. 30. Specifically, a start time, an end time, and a player name are associated with the video ID. A time point at which the player name specified from the gameplay video changes is set as the end time of the player name so far, and the player name after the change is set as the start time.

In the trigger detection processing by the first information creation unit 103 of the first embodiment, as illustrated in FIG. 13, the method of determining that a trigger is detected when a decrease amount in vitality is equal to or greater than the threshold value th8 has been described. Whereas, in the second embodiment, the first information creation unit 103 only updates display of immediately preceding vitality to display of current vitality and does not perform trigger detection processing, for a certain time period from detection of switching of the gameplay video to a gameplay video of another player.

This is because display of vitality after switching of the gameplay video to a gameplay video of another player indicates vitality of different player before switching of the gameplay video, and thus different vitality is to be detected as a difference.

Switching of the gameplay video to a gameplay video of another player can be detected by holding video information supplied from the pre-processing unit 101 in advance in the first information creation unit 103, and comparing previously referred video information with the most recent video information. By doing such a way, erroneous detection of a trigger can be prevented.

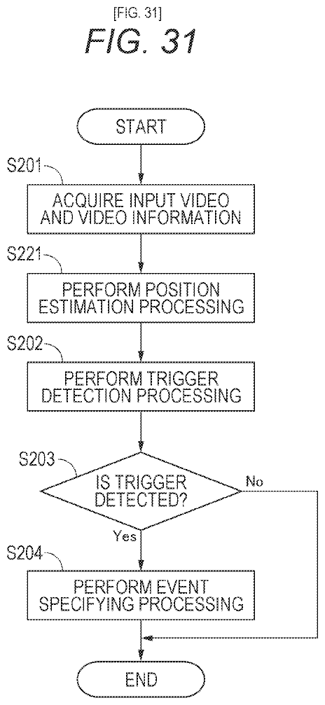

Furthermore, as illustrated in FIG. 31, in the processing in the first information creation unit 103 of the second embodiment, position estimation processing of step S221 is performed between step S201 and step S202.

In the position estimation processing of step S221, a position of the player on the game field is estimated from a currently input gameplay video, and is stored in the information storage unit 104 as a set of the current time, the video ID, and the estimated position.

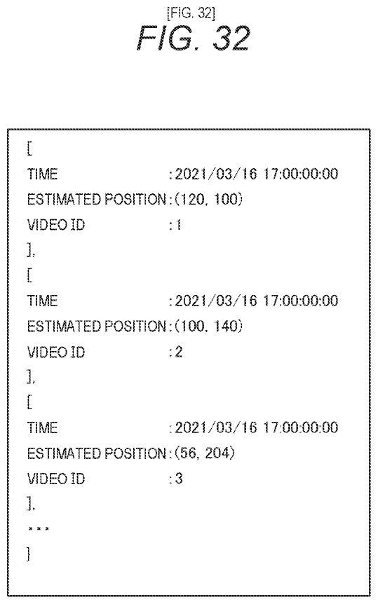

The position estimation processing can be performed using a map video showing the entire game field. FIG. 32 is an example of estimated position information stored in the information storage unit 104 in association with the video ID. The estimated position information is described with, for example, a value corresponding to latitude and longitude on the game field. Furthermore, a time at which the position is estimated is also stored in association with the video ID. As a result, the estimated positions of some players at the designated time can be obtained.

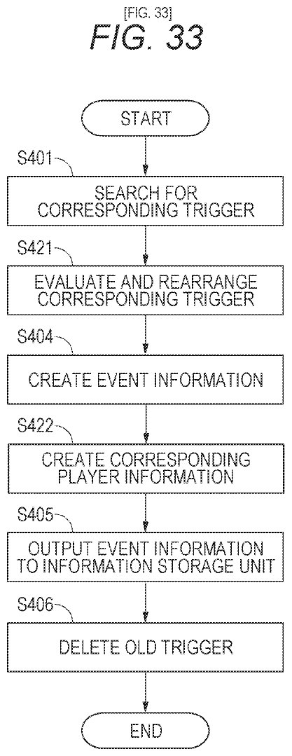

FIG. 33 is a flowchart of event specifying processing in the first information creation unit 103 according to the second embodiment. Note that steps S401, S404, S405, and S406 are similar to the processing in the first embodiment.

Processing of step S421 is basically similar to that of step S403 in the first embodiment. However, in the second embodiment, as the evaluation value calculation method for a corresponding trigger, an evaluation value calculation method for a corresponding trigger using the map video showing the entire game field and the estimated position of the player illustrated in FIG. 18 is executed.

Furthermore, the position of the detection trigger estimated in the process of the evaluation value calculation is held in the first information creation unit 103. Note that, in a case where the number of corresponding triggers is 0, it is not necessary to calculate a difference from the corresponding trigger.

In step S422, how much each player is involved in the event whose event information is created in step S404 is calculated and added to the event information as a corresponding player name.

First, estimated positions of the players within a past “past” [sec] set in advance are acquired for the number of players whose estimated positions are known. Specifically, time position information indicating when each player has been at which position in the game field is acquired, on the basis of section information additionally associated with the video ID included in the video information and indicating which section of the gameplay video belongs to which player's gameplay video as illustrated in FIG. 30, and on the basis of the estimated position information illustrated in FIG. 32 additionally stored in the video storage unit 102. When a plurality of estimated positions is known for the same player name, the estimated position at a time closest to the current time among estimated positions is set as the estimated position of the player.

Thereafter, a set of the player name and the evaluation value is created using the section information, the estimated position information, and the time position information. The evaluation value here is a value that can be calculated using, as inputs, a time of each player, the estimated position at the time, and the estimated position of the detection trigger, and indicates a possibility that each player in the event is involved.

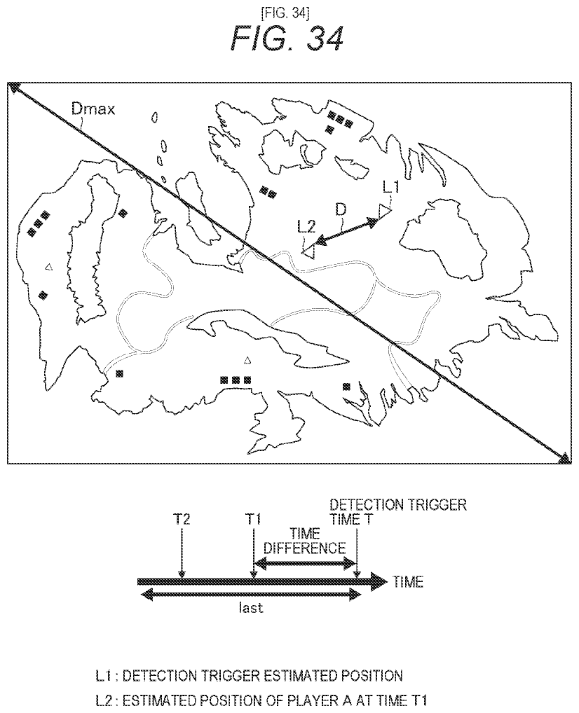

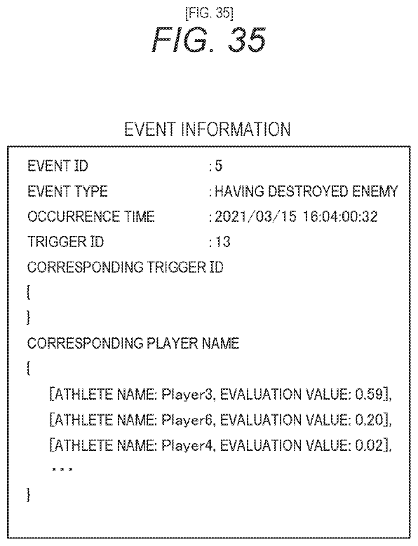

The evaluation value can be calculated by a method illustrated in FIG. 34. In a calculation formula for calculating the evaluation value illustrated in FIG. 34, it can be determined that a possibility that the player is involved in the event is relatively high as the evaluation value approaches 1. Here, a simple calculation formula has been described as an example. However, without limiting to this calculation formula, calculation for a distance and calculation for a time may be weighted, or a calculation method or the like may be adopted in which a higher evaluation value is obtained as the distance or the time is closer. After the evaluation value is calculated for the player whose estimated position is known, a pair of the player name and the evaluation value is added to the event information. The event information after being added is as illustrated in FIG. 35.

As described above, by quantifying how much each player is likely to be involved in each event within a known range, it is possible to estimate the player involved in the event even in a case where there is no corresponding trigger. By creating the output video by using the video ID of the player most involved in the event, for example, it is possible to increase a possibility that the player who has attacked and the player who has been attacked can be simultaneously included in the output video.

In the second embodiment, the information storage unit 104 stores a set of the current time, the video ID, and the estimated position additionally created by the first information creation unit 103. Furthermore, the corresponding player name in the event information newly created by the first information creation unit 103 is additionally stored.

The video processing unit 106 determines a material video to be associated with creation of an output video by using information newly created in the second embodiment, and creates the output video by using the material video.

For example, in a case where there is no corresponding trigger ID in the event information or in a case where there is a corresponding trigger ID in the event information but the evaluation value is extremely low, the output video can be created using a player name having a highest evaluation value among corresponding player names. By using the player name, the creation of the output video can be realized by switching a gameplay video of any player to the gameplay video of the player of the player name, to prepare as the video ID of the video creation method.

Furthermore, even in a case where a person designates a video creation method or the like by looking at event information or the like, a video having a high possibility of being involved in the event can be consciously used in the video creation, by looking at the corresponding player name of the event information and the evaluation value thereof. As a result, a possibility of being able to output a video that seems to be exciting and a video of two players who are engaged in a battle increases, and the viewer can be consequently entertained more.

The processing in the second embodiment is performed as described above. In the second embodiment, even in a situation where the gameplay videos of all the players cannot be obtained simultaneously, by estimating positions of players on the game field and accumulating the estimated position information, a player who may have been involved in the event can be estimated from the estimated positions of the players and reflected in the creation of the output video. As a result, for example, in a case where the output video is created on the basis of event information of an event of having attacked an enemy, a player who may have been involved in the event can be estimated and reflected in the creation of the output video.

### [2-3. Another Example of Trigger Detection Processing]

### 2-3-1. First Example

In the second embodiment, a player involved in an event is estimated by calculating a distance between players, but the distance between players can also be used as a trigger. By calculating the distance between players, reduction of the distance between players can be treated as a trigger.

As a method of this trigger detection processing, the method of obtaining a set of a corresponding player name and an evaluation value thereof described with reference to FIG. 34 is used. By using an estimated position that can be obtained from a gameplay video of a player acquired from the pre-processing unit 101 instead of a detection trigger estimated position, the set of the corresponding player name and the evaluation value thereof is calculated. Then, when a highest evaluation value is equal to or greater than a threshold value th14, it is regarded that a trigger that a distance between two players has been reduced is detected. Trigger detailed information of the detected trigger is a player name having the highest evaluation value.

Note that, by setting the corresponding trigger of this trigger not to exist, creation of an unnecessary event is prevented. Further, a similar trigger can be added also in the first embodiment by adding, to the first embodiment, only information necessary for the trigger detection processing method and processing for obtaining the information.

In this way, by detecting reduction of a distance between two players as a trigger, it is possible to estimate two players between which a battle or an event is likely to occur in the near future, particularly in a case where a real-time output video is created.

By using this trigger, as the video creation method of the video processing unit 106, it is possible to add a video creation method in which, when there is no event or event scene at the present time, a video ID having a high possibility that an event or an event scene will appear in the near future is set as a material video in advance.

### 2-3-2. Second Example

In a second example of another trigger detection method, it is assumed that a trigger is detected when there is a change in a state of a player in a player video instead of the gameplay video.

In this case, a video type of the player video is set in advance as the trigger detection target video type. The first information creation unit 103 performs the trigger detection processing on an input video whose video type is the player video. Specifically, first, posture estimation processing as state estimation is performed on the player video to estimate a posture (position of a bone) of the player, and a set of the estimated posture information, a current time, and a player name is held by the first information creation unit 103.

Then, after player name information included in the video information whose video type is the player video is acquired, video information having the same player name within a certain time period in the past from the current time is searched. When the video information is found, the posture estimation processing is also performed on the player video that can be specified by the video ID included in the video information. Then, a movement amount of the position of the bone is calculated using the estimated posture information in the two player videos, and it is regarded that the trigger is detected in a case where the sum is equal to or greater than a threshold value th15.

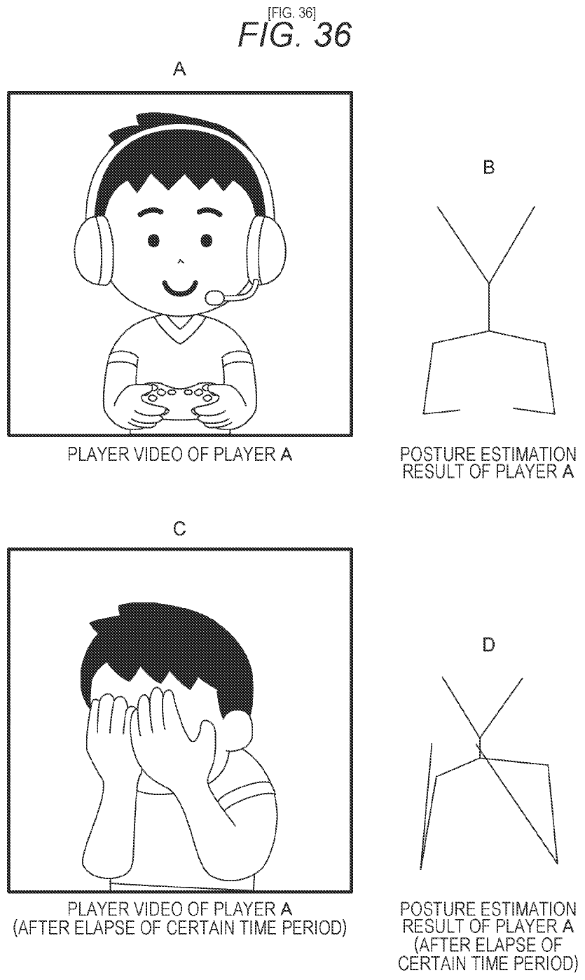

FIG. 36 is an example of a position of a bone detected by posture estimation. FIG. 36A is a player video of Player A, and FIG. 36B is a posture estimation result in the player video. FIG. 37C is a player video of Player A after a lapse of a certain time period, and FIG. 36D is a posture estimation result in the player video.

Since the position of the bone changes when the posture changes in this manner, the trigger detection processing can be performed on the basis of this change amount. Note that, by setting that there is no corresponding trigger in the trigger detected from the estimated bone information, it is possible to prevent creation of an unnecessary event.

Note that the change in the state of the player is not limited to the change in the position of the bone. In addition to the position of the bone or instead of the position of the bone, a position of a joint may be estimated, and the trigger detection processing may be performed on the basis of a change amount of the position of the joint. Moreover, detection processing for line-of-sight of the player may be performed, and the trigger detection processing may be performed on the basis of a change amount of a position of the line-of-sight of the player.

By performing the trigger detection processing on the basis of the state of the player in the player video, it is possible to detect a trigger that cannot be sufficiently detected in the gameplay video. For example, a case is considered in which an instance of “being destroyed by an enemy” has failed to be detected as a trigger due to an unexpected operation of the player. For example, in a case where a posture of a player destroyed by an enemy while a match is in progress changes to a posture of holding the head, the trigger detection processing can be performed by detecting the change in the state of the player by the method described above.

### 3. Modifications

Although the embodiments of the present technology have been specifically described above, the present technology is not limited to the above-described embodiments, and various modifications based on the technical idea of the present technology are possible.

The embodiments have been described with an example of the competitive game in which a large number of players battle on a field and aim to win and survive, but the game is not limited thereto. For example, the game may be a game in which a plurality of players forms one team and fights against an enemy team on a game field, a game of competition such as a race, a game such as a puzzle, or any game as long as a plurality of players participates. In that case, it is necessary to set in advance a trigger detection method or the like according to a video of each game.

Furthermore, the present technology can be used not only in a game but also in a case where a digest video or a highlight video is created from a video obtained by image capture of various events such as a music event and a talk event.

In the embodiments, two information creation units, that is, the first information creation unit 103 and the second information creation unit 105 create video creation information, but one information creation unit may create all pieces of video creation information.

The present technology can also have the following configurations.

(1)

A video processing apparatus including:
an information creation unit configured to create video creation information on the basis of a plurality of triggers detected from a plurality of input videos; and
a video processing unit configured to determine a material video to be associated with creation of an output video from among the plurality of input videos, on the basis of the video creation information.
   (2)

The video processing apparatus according to (1), in which the information creation unit creates trigger information as the video creation information, on the basis of a plurality of the triggers.

(3)

The video processing apparatus according to (2), in which the trigger information includes a video ID for identification of each of the input videos in which each of the triggers has been detected.

(4)

The video processing apparatus according to (2) or (3), in which the trigger information includes trigger type information indicating a type of each of the triggers.

(5)

The video processing apparatus according to (1), in which each of the triggers is a characteristic instance that has occurred in each of the input videos.

(6)

The video processing apparatus according to (2), in which the information creation unit creates event information as the video creation information on the basis of the trigger information.

(7)

The video processing apparatus according to (6), in which the event information includes a trigger ID for identification of a target trigger and a corresponding trigger corresponding to the target trigger, the target trigger and the corresponding trigger being any of the plurality of triggers and constituting an event.

(8)

The video processing apparatus according to (7), in which the event information includes event type information indicating a type of an event.

(9)

The video processing apparatus according to (7), in which the information creation unit creates event scene information as the video creation information on the basis of the event information.

(10)

The video processing apparatus according to (9), in which the event scene information includes an event ID for identification of the event constituting an event scene.

(11)

The video processing apparatus according to any one of (1) to (10), in which the information creation unit creates statistical information as the video creation information on the basis of the trigger information.

(12)

The video processing apparatus according to (3), in which the video processing unit determines, as the material video, each of the input videos that can be specified by the video ID included in the trigger information.

(13)

The video processing apparatus according to (7), in which the video processing unit determines, as the material video, each of the input videos that can be specified by the video ID included in the trigger information indicated by the trigger ID included in the event information.

(14)

The video processing apparatus according to (10), in which the video processing unit determines, as the material video, each of the input videos that can be specified by the video ID included in the event scene information.

(15)

The video processing apparatus according to any one of (1) to (14), in which the video processing unit creates the output video by using the material video associated with creation of the output video.

(16)

The video processing apparatus according to (15), in which the video processing unit arranges a plurality of the material videos in one video to create the output video.

(17)

The video processing apparatus according to any one of (1) to (16), in which each of the input videos is a gameplay video output from a game machine.

(18)

The video processing apparatus according to any one of (1) to (17), in which each of the input videos is a video obtained by image capture of a player playing a game.

(19)

A video processing method including:
creating video creation information on the basis of a plurality of triggers detected from a plurality of input videos; and
determining a material video to be associated with creation of an output video from among the plurality of input videos, on the basis of the video creation information.
   (20)

A program for causing a computer to execute a video processing method including:
creating video creation information on the basis of a plurality of triggers detected from a plurality of input videos; and
determining a material video to be associated with creation of an output video from among the plurality of input videos, on the basis of the video creation information.

### REFERENCE SIGNS LIST

100 Video processing apparatus
103 First video processing unit
105 Second information creation unit

1. A video processing apparatus comprising:
an information creation unit configured to create video creation information on a basis of a plurality of triggers detected from a plurality of input videos; and
a video processing unit configured to determine a material video to be associated with creation of an output video from among the plurality of input videos, on a basis of the video creation information.

2. The video processing apparatus according to claim 1, wherein
the information creation unit creates trigger information as the video creation information, on a basis of a plurality of the triggers.

3. The video processing apparatus according to claim 2, wherein
the trigger information includes a video ID for identification of each of the input videos in which each of the triggers has been detected.

4. The video processing apparatus according to claim 2, wherein
the trigger information includes trigger type information indicating a type of each of the triggers.

5. The video processing apparatus according to claim 1, wherein
each of the triggers is a characteristic instance that has occurred in each of the input videos.

6. The video processing apparatus according to claim 2, wherein
the information creation unit creates event information as the video creation information on a basis of the trigger information.

7. The video processing apparatus according to claim 6, wherein
the event information includes a trigger ID for identification of a target trigger and a corresponding trigger corresponding to the target trigger, the target trigger and the corresponding trigger being any of the plurality of triggers and constituting an event.

8. The video processing apparatus according to claim 7, wherein
the event information includes event type information indicating a type of an event.

9. The video processing apparatus according to claim 7, wherein
the information creation unit creates event scene information as the video creation information on a basis of the event information.

10. The video processing apparatus according to claim 9, wherein
the event scene information includes an event ID for identification of the event constituting an event scene.

11. The video processing apparatus according to claim 1, wherein
the information creation unit creates statistical information as the video creation information on a basis of the trigger information.

12. The video processing apparatus according to claim 3, wherein
the video processing unit determines, as the material video, each of the input videos that can be specified by the video ID included in the trigger information.

13. The video processing apparatus according to claim 7, wherein
the video processing unit determines, as the material video, each of the input videos that can be specified by the video ID included in the trigger information indicated by the trigger ID included in the event information.

14. The video processing apparatus according to claim 10, wherein
the video processing unit determines, as the material video, each of the input videos that can be specified by the video ID included in the event scene information.

15. The video processing apparatus according to claim 1, wherein
the video processing unit creates the output video by using the material video associated with creation of the output video.

16. The video processing apparatus according to claim 15, wherein
the video processing unit arranges a plurality of the material videos in one video to create the output video.

17. The video processing apparatus according to claim 1, wherein
each of the input videos is a gameplay video output from a game machine.

18. The video processing apparatus according to claim 1, wherein
each of the input videos is a video obtained by image capture of a player playing a game.

19. A video processing method comprising:
creating video creation information on a basis of a plurality of triggers detected from a plurality of input videos; and
determining a material video to be associated with creation of an output video from among the plurality of input videos, on a basis of the video creation information.

20. A program for causing a computer to execute a video processing method comprising:
creating video creation information on a basis of a plurality of triggers detected from a plurality of input videos; and
determining a material video to be associated with creation of an output video from among the plurality of input videos, on a basis of the video creation information.
